(19) United States
(12) Patent Application Publication
(10) Pub. No.: US 2015/0134481 A1
(43) Pub. Date: May 14, 2015

(54) SYSTEMS AND METHODS TO FACILITATE JOINT PURCHASES AND TRACK JOINT PURCHASE OWNERSHIP DISTRIBUTIONS

(71) Applicant: QUALCOMM Incorporated, San Diego, CA (US)

(72) Inventors: Sarah GLICKFIELD, Jerusalem (IL); Isaac David GUEDALIA, Bet Shemesh (IL)

(21) Appl. No.: 14/531,750

(22) Filed: Nov. 3, 2014

Related U.S. Application Data
(60) Provisional application No. 61/901,785, filed on Nov. 8, 2013.

(51) Int. Cl. G06Q 30/06

(52) U.S. Cl. CPC G06Q 30/0609
USPC 705/26.35

(57) ABSTRACT

The disclosure relates to facilitating and tracking joint purchases among multiple parties. More particularly, multiple parties may use a joint purchasing service to jointly purchase one or more items according to a consecutive, concurrent, or other ownership distribution that the parties agreed upon, and the joint purchasing service may implement one or more controls to track and maintain the ownership distribution. For example, locations associated with jointly purchased items may be tracked such that joint purchasers may be notified when possession should be transferred (e.g., when the current owner's turn expires, when one owner exceeds a usage proportion allocated thereto, etc.). Furthermore, ownership over certain jointly purchased items may be automatically managed (e.g., an electronic item may be transferred from one joint owner to another when the current owner's turn expires, joint owners may be required to be in proximity to use the item, etc.).

### CROSS-REFERENCE TO RELATED APPLICATIONS

The present application for patent claims the benefit of Provisional Patent Application No. 61/901,785 entitled “SYSTEMS AND METHODS TO FACILITATE JOINT PURCHASES AND TRACK JOINT PURCHASE OWNERSHIP DISTRIBUTIONS,” filed Nov. 8, 2013, and assigned to the assignee hereof and hereby expressly incorporated herein by reference in its entirety.

### TECHNICAL FIELD

Various embodiments described herein generally relate to facilitating a joint purchase among multiple parties and tracking a joint purchase ownership distribution among the multiple parties to the joint purchase.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

As such, in the near future, increasing development in IoT technologies will lead to numerous IoT devices surrounding a user at home, in vehicles, at work, and many other locations. Furthermore, as online shopping grows exponentially, consumers will be exposed to more and more products and services that are available to purchase from around the world. However, economic conditions may hinder vendors from earning the revenue that they seek and potential buyers are often forced to abandon items that they may otherwise like to purchase simply due to budgetary considerations. The current electronic commerce marketplace does not consumers the opportunity to split costs and thereby purchase products or services jointly in order to make otherwise prohibitively expensive purchases more affordable and limit the cost to each particular consumer, nor do existing electronic commerce systems provide simple and convenient mechanisms to ensure that ownership distributions over jointly purchased items are properly maintained.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments disclosed herein in a simplified form to precede the detailed description presented below.

According to various aspects, a joint purchase among multiple parties may be facilitated and tracked according to an ownership distribution that the multiple parties to the joint purchase have agreed upon. More particularly, a joint purchasing service may enable multiple parties to jointly purchase one or more items according to a consecutive, concurrent, or other ownership distribution that the multiple parties agree upon, and the joint purchasing service may implement one or more controls to track and maintain the agreed-upon ownership distribution. For example, current locations associated with the jointly purchased items may be tracked such that joint purchasers may be appropriately notified when possession should be transferred (e.g., when the current user's turn expires, when one user exceeds a usage proportion allocated thereto, etc.). Furthermore, jointly purchased electronic items may be automatically managed (e.g., an item may be transferred from one user to another when the current user's turn expires, the parties may be required to be in proximity to another to use the item, etc.). Further still, in various embodiments, the joint purchasing service may provide an application or other suitable user interface that the multiple parties to the joint purchase may use to view the jointly purchased items, information relating to locations, usage statistics, or other state data relating to the jointly purchased items, parties currently possessing the jointly purchased items, or other information relevant to the tracked ownership distribution (e.g., how long parties currently possessing jointly purchased items subject to a consecutive ownership distribution are scheduled to possess the jointly purchased items, whether parties that have jointly purchased items subject to a concurrent ownership distribution have exceeded a possession or usage proportion allocated thereto, etc.).

According to various embodiments, a method for managing joint purchases may comprise providing a joint purchasing service to facilitate a joint purchase among multiple parties that have agreed to enter into the joint purchase and tracking the joint purchase according to an ownership distribution that the multiple parties to the joint purchase have agreed upon, wherein the ownership distribution may defines one or more rules that control access to the joint purchase according to one or more of locations or proximity associated with the multiple parties.

According to various embodiments, a server may comprise means for facilitating a joint purchase among multiple parties that have agreed to enter into a joint purchase and means for tracking the joint purchase according to an ownership distribution that the multiple parties to the joint purchase have agreed upon, wherein the ownership distribution may define one or more rules that control access to the joint purchase according to one or more of locations or proximity associated with the multiple parties.

According to various embodiments, a computer-readable storage medium may have computer-executable instructions recorded thereon, wherein the computer-executable instructions, when executed on a server, may cause the server to facilitate a joint purchase among multiple parties that have agreed to enter into a joint purchase and track the joint purchase according to an ownership distribution that the multiple parties to the joint purchase have agreed upon, wherein the ownership distribution may define one or more rules that control access to the joint purchase according to one or more of locations or proximity associated with the multiple parties.

According to various embodiments, a method for making and tracking joint purchases may comprise communicating with a joint purchasing service using a device associated with a first user to initiate a joint purchase with one or more second users that have agreed to enter into the joint purchase with the first user, communicating with the joint purchasing service to specify an ownership distribution associated with the joint purchase, wherein the ownership distribution may define one or more rules that the first user and the one or more second users have agreed upon to control access to the joint purchase, receiving state information tracking one or more items associated with the joint purchase according to the specified ownership distribution at the device associated with the first user, wherein the received state information may track the one or more items according to one or more of location or proximity information, and displaying, at the device associated with the first user, information corresponding to the one or more items associated with the joint purchase and the received state information tracking the one or more items.

Other objects and advantages associated with the various aspects and embodiments disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1A illustrates a high-level system architecture of a wireless communications system in accordance with an aspect of the disclosure.

FIG. 1B illustrates a high-level system architecture of a wireless communications system in accordance with another aspect of the disclosure.

FIG. 1C illustrates a high-level system architecture of a wireless communications system in accordance with an aspect of the disclosure.

FIG. 1D illustrates a high-level system architecture of a wireless communications system in accordance with an aspect of the disclosure.

FIG. 1E illustrates a high-level system architecture of a wireless communications system in accordance with an aspect of the disclosure.

FIG. 2A illustrates an exemplary Internet of Things (IoT) device in accordance with aspects of the disclosure, while FIG. 2B illustrates an exemplary passive IoT device in accordance with aspects of the disclosure.

FIG. 3 illustrates a communication device that includes logic configured to perform functionality in accordance with an aspect of the disclosure.

FIG. 4 illustrates an exemplary server according to various aspects of the disclosure.

FIG. 5 illustrates a wireless communication network that may support discoverable peer-to-peer (P2P) services, in accordance with one aspect of the disclosure.

FIG. 6 illustrates an exemplary environment in which discoverable P2P services may be used to establish a proximity-based distributed bus over which various devices may communicate, in accordance with one aspect of the disclosure.

FIG. 7 illustrates an exemplary message sequence in which discoverable P2P services may be used to establish a proximity-based distributed bus over which various devices may communicate, in accordance with one aspect of the disclosure.

FIGS. 8A-8B illustrate exemplary systems to facilitate a joint purchase among multiple parties and track a joint purchase ownership distribution among the multiple parties to the joint purchase, according to one aspect of the disclosure.

FIG. 9 illustrates an exemplary database that may be used to facilitate a joint purchase among multiple parties and track a joint purchase ownership distribution among the multiple parties to the joint purchase, according to one aspect of the disclosure.

FIG. 10 illustrates an exemplary method that may be used to facilitate a joint purchase among multiple parties and track a joint purchase ownership distribution among the multiple parties to the joint purchase, according to one aspect of the disclosure.

FIG. 11 illustrates an exemplary method that may be used to manage a joint purchase among multiple parties according to an ownership distribution requiring concurrent use among the multiple parties, according to one aspect of the disclosure.

FIG. 12 illustrates an exemplary communications device that may support discoverable P2P services to communicate over a proximity-based distributed bus with other communications devices to track and manage joint purchase ownership distributions, in accordance with one aspect of the disclosure.

### DETAILED DESCRIPTION

Various aspects are disclosed in the following description and related drawings to show specific examples relating to exemplary aspects and embodiments disclosed herein. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

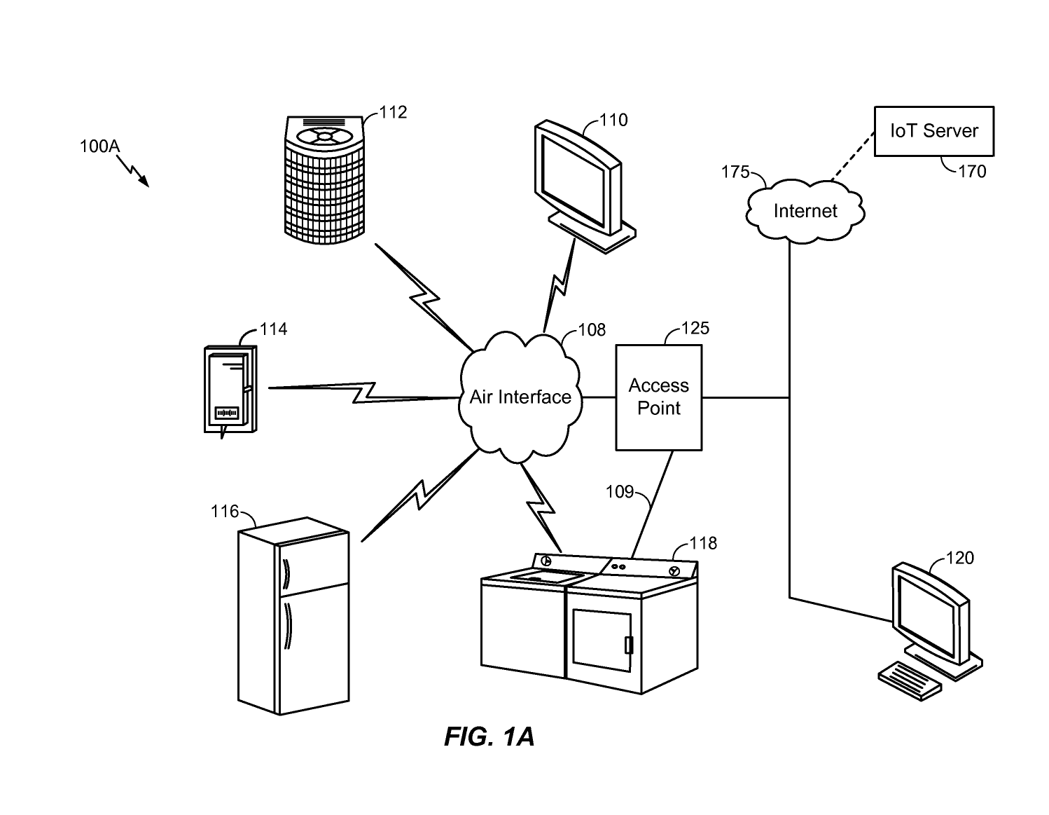

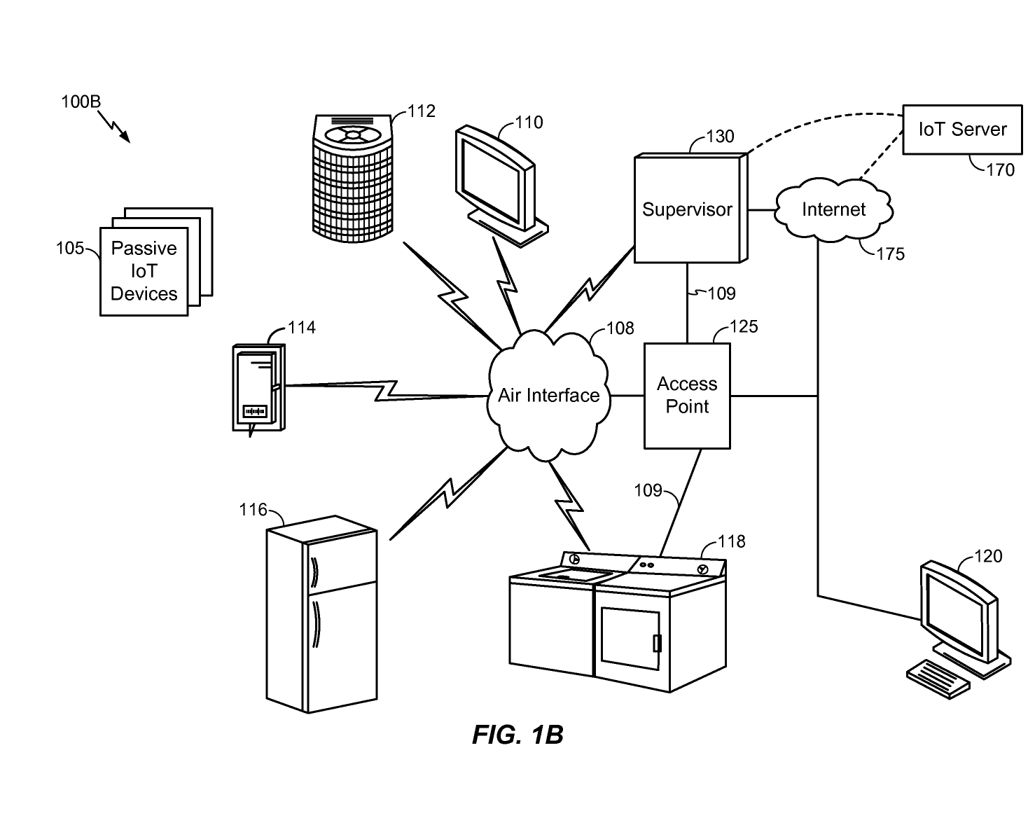

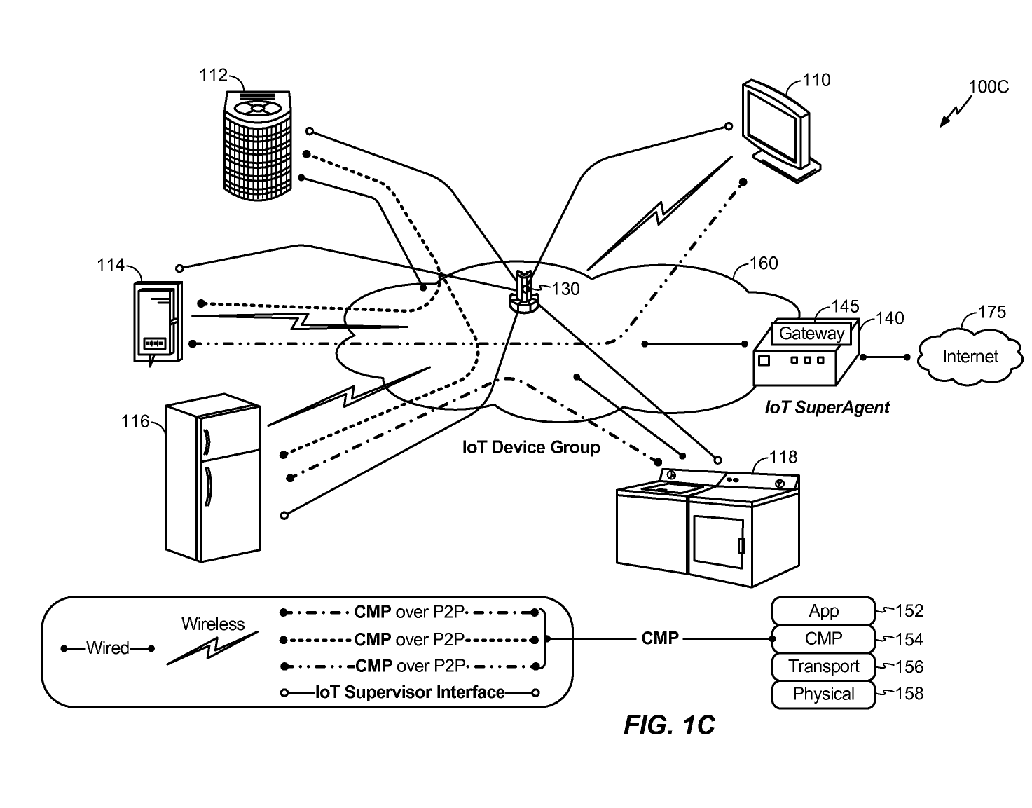

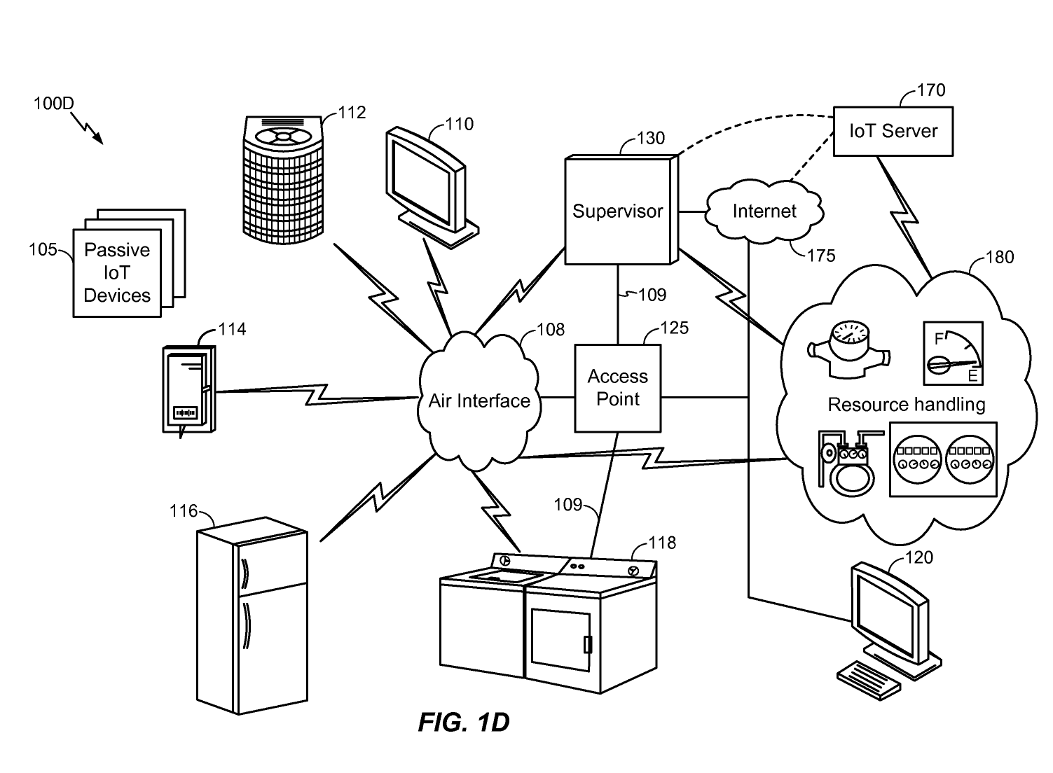

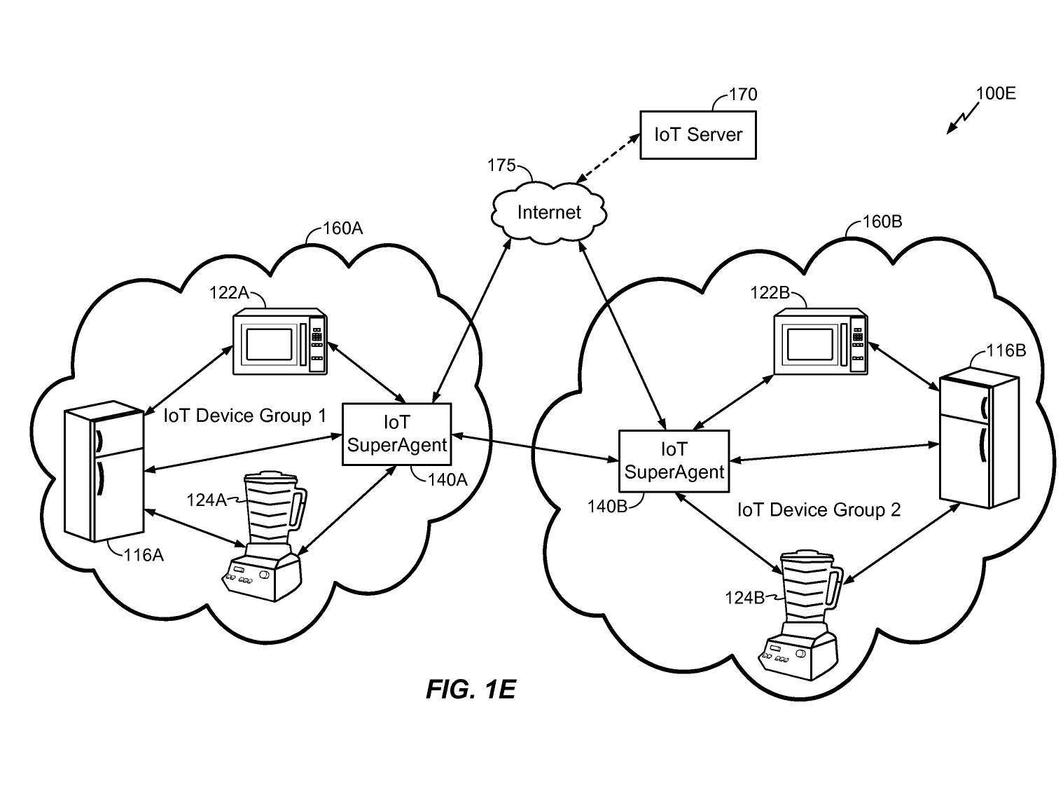

FIG. 1A illustrates a high-level system architecture of a wireless communications system 100A in accordance with an aspect of the disclosure. The wireless communications system 100A contains a plurality of IoT devices, which include a television 110, an outdoor air conditioning unit 112, a thermostat 114, a refrigerator 116, and a washer and dryer 118.

Referring to FIG. 1A, IoT devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates IoT devices 110-118 communicating over the air interface 108 and IoT device 118 communicating over the direct wired connection 109, each IoT device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 itself (e.g., for a Wi-Fi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface 108. Although illustrated as a desktop computer, computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In an aspect, the IoT server 170 is optional (as indicated by the dotted line), and the group of IoT devices 110-120 may be a peer-to-peer (P2P) network. In such a case, the IoT devices 110-120 can communicate with each other directly over the air interface 108 and/or the direct wired connection 109. Alternatively, or additionally, some or all of IoT devices 110-120 may be configured with a communication interface independent of air interface 108 and direct wired connection 109. For example, if the air interface 108 corresponds to a Wi-Fi interface, one or more of the IoT devices 110-120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with an aspect of the disclosure, FIG. 1B illustrates a high-level architecture of another wireless communications system 100B that contains a plurality of IoT devices. In general, the wireless communications system 100B shown in FIG. 1B may include various components that are the same and/or substantially similar to the wireless communications system 100A shown in FIG. 1A, which was described in greater detail above (e.g., various IoT devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet 175 through access point 125, and an IoT server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130, which may alternatively be referred to as an IoT manager 130 or IoT manager device 130. As such, where the following description uses the term “supervisor device” 130, those skilled in the art will appreciate that any references to an IoT manager, group owner, or similar terminology may refer to the supervisor device 130 or another physical or logical component that provides the same or substantially similar functionality.

In one embodiment, the supervisor device 130 may generally observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various IoT devices 110-120 in the wireless communications system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-120. The supervisor device 130 may be a standalone device or one of IoT devices 110-120, such as computer 120. The supervisor device 130 may be a physical device or a software application running on a physical device. The supervisor device 130 may include a user interface that can output information relating to the monitored attributes, activities, or other states associated with the IoT devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive IoT devices 105 (in contrast to the active IoT devices 110-120) that can be coupled to or otherwise made part of the wireless communications system 100B. In general, the passive IoT devices 105 may include barcoded devices, Bluetooth devices, radio frequency (RF) devices, RFID tagged devices, infrared (IR) devices, NFC tagged devices, or any other suitable device that can provide its identifier and attributes to another device when queried over a short range interface. Active IoT devices may detect, store, communicate, act on, and/or the like, changes in attributes of passive IoT devices.

For example, passive IoT devices 105 may include a coffee cup and a container of orange juice that each have an RFID tag or barcode. A cabinet IoT device and the refrigerator IoT device 116 may each have an appropriate scanner or reader that can read the RFID tag or barcode to detect when the coffee cup and/or the container of orange juice passive IoT devices 105 have been added or removed. In response to the cabinet IoT device detecting the removal of the coffee cup passive IoT device 105 and the refrigerator IoT device 116 detecting the removal of the container of orange juice passive IoT device, the supervisor device 130 may receive one or more signals that relate to the activities detected at the cabinet IoT device and the refrigerator IoT device 116. The supervisor device 130 may then infer that a user is drinking orange juice from the coffee cup and/or likes to drink orange juice from a coffee cup.

Although the foregoing describes the passive IoT devices 105 as having some form of RFID tag or barcode communication interface, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate its identity and attributes and become part of the wireless communication system 100B and be observed, monitored, controlled, or otherwise managed with the supervisor device 130. Further, passive IoT devices 105 may be coupled to or otherwise made part of the wireless communications system 100A in FIG. 1A and observed, monitored, controlled, or otherwise managed in a substantially similar manner.

In accordance with another aspect of the disclosure, FIG. 1C illustrates a high-level architecture of another wireless communications system 100C that contains a plurality of IoT devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The communications system 100C shown in FIG. 1C illustrates exemplary peer-to-peer communications between the IoT devices 110-118 and the supervisor device 130. As shown in FIG. 1C, the supervisor device 130 communicates with each of the IoT devices 110-118 over an IoT supervisor interface. Further, IoT devices 110 and 114, IoT devices 112, 114, and 116, and IoT devices 116 and 118, communicate directly with each other.

The IoT devices 110-118 make up an IoT group 160. An IoT device group 160 is a group of locally connected IoT devices, such as the IoT devices connected to a user's home network. Although not shown, multiple IoT device groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor device 130 and the IoT SuperAgent 140 may be, or reside on, the same device (e.g., a standalone device or an IoT device, such as computer 120 in FIG. 1A). Alternatively, the IoT SuperAgent 140 may correspond to or include the functionality of the access point 125. As yet another alternative, the IoT SuperAgent 140 may correspond to or include the functionality of an IoT server, such as IoT server 170. The IoT SuperAgent 140 may encapsulate gateway functionality 145.

Each IoT device 110-118 can treat the supervisor device 130 as a peer and transmit attribute/schema updates to the supervisor device 130. When an IoT device needs to communicate with another IoT device, it can request the pointer to that IoT device from the supervisor device 130 and then communicate with the target IoT device as a peer. The IoT devices 110-118 communicate with each other over a peer-to-peer communication network using a common messaging protocol (CMP). As long as two IoT devices are CMP-enabled and connected over a common communication transport, they can communicate with each other. In the protocol stack, the CMP layer 154 is below the application layer 152 and above the transport layer 156 and the physical layer 158.

In accordance with another aspect of the disclosure, FIG. 1D illustrates a high-level architecture of another wireless communications system 100D that contains a plurality of IoT devices. In general, the wireless communications system 100D shown in FIG. 1D may include various components that are the same and/or substantially similar to the wireless communications systems 100A-100C shown in FIGS. 1A-1C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-100C illustrated in FIGS. 1A-1C, respectively.

The Internet 175 is a “resource” that can be regulated using the concept of the IoT. However, the Internet 175 is just one example of a resource that is regulated, and any resource could be regulated using the concept of the IoT. Other resources that can be regulated include, but are not limited to, electricity, gas, storage, security, and the like. An IoT device may be connected to the resource and thereby regulate it, or the resource could be regulated over the Internet 175. FIG. 1D illustrates several resources 180, such as natural gas, gasoline, hot water, and electricity, wherein the resources 180 can be regulated in addition to and/or over the Internet 175.

IoT devices can communicate with each other to regulate their use of a resource 180. For example, IoT devices such as a toaster, a computer, and a hairdryer may communicate with each other over a Bluetooth communication interface to regulate their use of electricity (the resource 180). As another example, IoT devices such as a desktop computer, a telephone, and a tablet computer may communicate over a Wi-Fi communication interface to regulate their access to the Internet 175 (the resource 180). As yet another example, IoT devices such as a stove, a clothes dryer, and a water heater may communicate over a Wi-Fi communication interface to regulate their use of gas. Alternatively, or additionally, each IoT device may be connected to an IoT server, such as IoT server 170, which has logic to regulate their use of the resource 180 based on information received from the IoT devices.

In accordance with another aspect of the disclosure, FIG. 1E illustrates a high-level architecture of another wireless communications system 100E that contains a plurality of IoT devices. In general, the wireless communications system 100E shown in FIG. 1E may include various components that are the same and/or substantially similar to the wireless communications systems 100A-100D shown in FIGS. 1A-1D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-100D illustrated in FIGS. 1A-1D, respectively.

The communications system 100E includes two IoT device groups 160A and 160B. Multiple IoT device groups may be connected to and/or communicate with each other via an IoT SuperAgent connected to the Internet 175. At a high level, an IoT SuperAgent may manage inter-group communications among IoT device groups. For example, in FIG. 1E, the IoT device group 160A includes IoT devices 116A, 122A, and 124A and an IoT SuperAgent 140A, while IoT device group 160B includes IoT devices 116B, 122B, and 124B and an IoT SuperAgent 140B. As such, the IoT SuperAgents 140A and 140B may connect to the Internet 175 and communicate with each other over the Internet 175 and/or communicate with each other directly to facilitate communication between the IoT device groups 160A and 160B. Furthermore, although FIG. 1E illustrates two IoT device groups 160A and 160B communicating with each other via IoT SuperAgents 140A and 140B, those skilled in the art will appreciate that any number of IoT device groups may suitably communicate with each other using IoT SuperAgents.

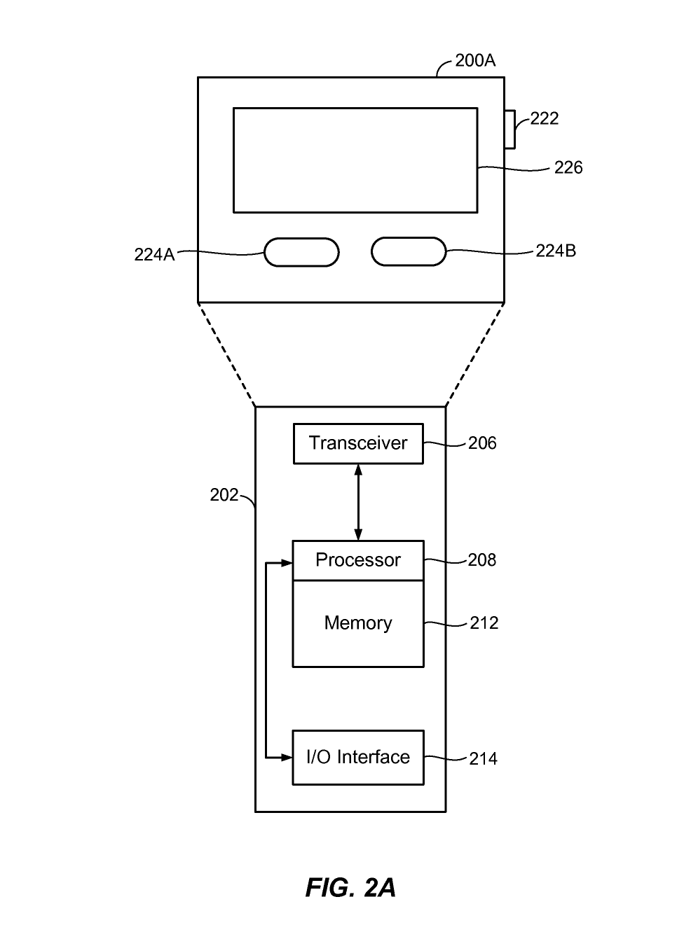

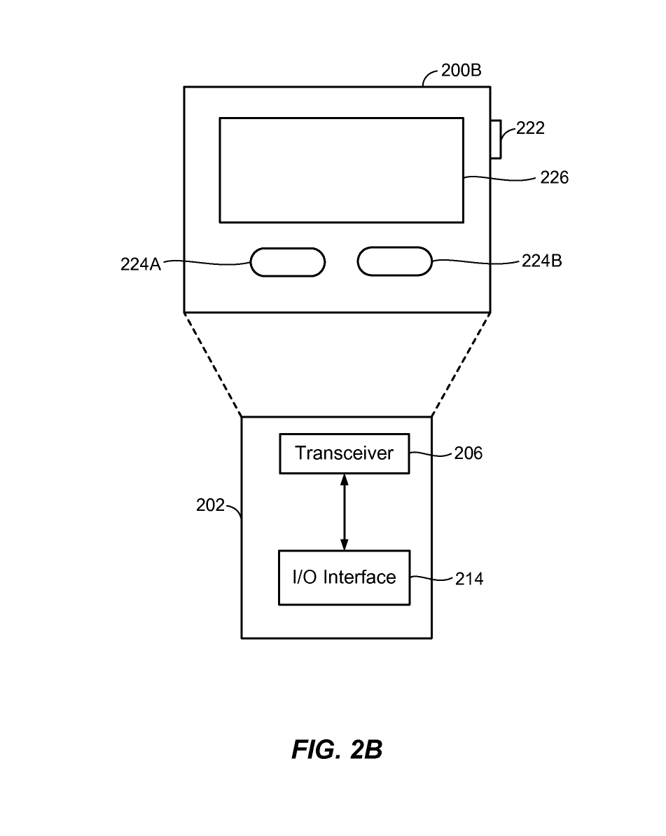

FIG. 2A illustrates a high-level example of an IoT device 200A in accordance with aspects of the disclosure. While external appearances and/or internal components can differ significantly among IoT devices, most IoT devices will have some sort of user interface, which may comprise a display and a means for user input. IoT devices without a user interface can be communicated with remotely over a wired or wireless network, such as air interface 108 in FIGS. 1A-1B.

As shown in FIG. 2A, in an example configuration for the IoT device 200A, an external casing of IoT device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of IoT device 200A, the IoT device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as IoT device 200A, can be embodied with different hardware configurations, a basic high-level configuration for internal hardware components is shown as platform 202 in FIG. 2A. The platform 202 can receive and execute software applications, data and/or commands transmitted over a network interface, such as air interface 108 in FIGS. 1A-1B and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as processor 208. The processor 208 can execute application programming instructions within a memory 212 of the IoT device. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display 226, power button 222, control buttons 224A and 224B as illustrated, and any other devices, such as sensors, actuators, relays, valves, switches, and the like associated with the IoT device 200A.

Accordingly, an aspect of the disclosure can include an IoT device (e.g., IoT device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the IoT device 200A in FIG. 2A are to be considered merely illustrative and the disclosure is not limited to the illustrated features or arrangement.

FIG. 2B illustrates a high-level example of a passive IoT device 200B in accordance with aspects of the disclosure. In general, the passive IoT device 200B shown in FIG. 2B may include various components that are the same and/or substantially similar to the IoT device 200A shown in FIG. 2A, which was described in greater detail above. As such, for brevity and ease of description, various details relating to certain components in the passive IoT device 200B shown in FIG. 2B may be omitted herein to the extent that the same or similar details have already been provided above in relation to the IoT device 200A illustrated in FIG. 2A.

The passive IoT device 200B shown in FIG. 2B may generally differ from the IoT device 200A shown in FIG. 2A in that the passive IoT device 200B may not have a processor, internal memory, or certain other components. Instead, in one embodiment, the passive IoT device 200B may only include an I/O interface 214 or other suitable mechanism that allows the passive IoT device 200B to be observed, monitored, controlled, managed, or otherwise known within a controlled IoT network. For example, in one embodiment, the I/O interface 214 associated with the passive IoT device 200B may include a barcode, Bluetooth interface, radio frequency (RF) interface, RFID tag, IR interface, NFC interface, or any other suitable I/O interface that can provide an identifier and attributes associated with the passive IoT device 200B to another device when queried over a short range interface (e.g., an active IoT device, such as IoT device 200A, that can detect, store, communicate, act on, or otherwise process information relating to the attributes associated with the passive IoT device 200B).

Although the foregoing describes the passive IoT device 200B as having some form of RF, barcode, or other I/O interface 214, the passive IoT device 200B may comprise a device or other physical object that does not have such an I/O interface 214. For example, certain IoT devices may have appropriate scanner or reader mechanisms that can detect shapes, sizes, colors, and/or other observable features associated with the passive IoT device 200B to identify the passive IoT device 200B. In this manner, any suitable physical object may communicate its identity and attributes and be observed, monitored, controlled, or otherwise managed within a controlled IoT network.

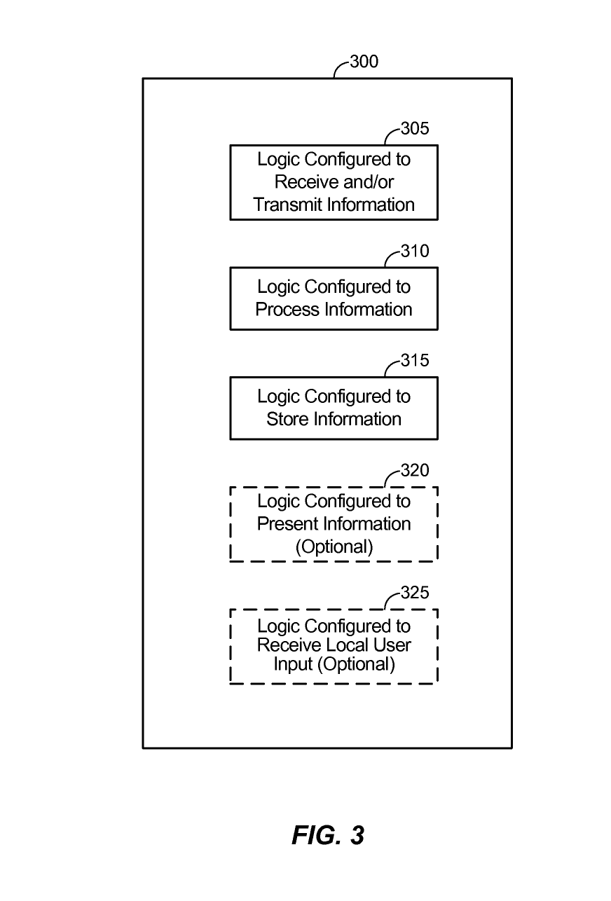

FIG. 3 illustrates a communication device 300 that includes logic configured to perform functionality. The communication device 300 can correspond to any of the above-noted communication devices, including but not limited to IoT devices 110-120, IoT device 200A, any components coupled to the Internet 175 (e.g., the IoT server 170), and so on. Thus, communication device 300 can correspond to any electronic device that is configured to communicate with (or facilitate communication with) one or more other entities over the wireless communications systems 100A-100E of FIGS. 1A-1E.

Referring to FIG. 3, the communication device 300 includes logic configured to receive and/or transmit information 305. In an example, if the communication device 300 corresponds to a wireless communications device (e.g., IoT device 200A and/or passive IoT device 200B), the logic configured to receive and/or transmit information 305 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the application 170), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the processor included in the logic configured to process information 310 can correspond to a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM, flash memory, ROM, erasable programmable ROM (EPROM), EEPROM, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the IoT device 200A as shown in FIG. 2A and/or the passive IoT device 200B as shown in FIG. 2B, the logic configured to present information 320 can include the display 226. In a further example, the logic configured to present information 320 can be omitted for certain communication devices, such as network communication devices that do not have a local user (e.g., network switches or routers, remote servers, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the IoT device 200A as shown in FIG. 2A and/or the passive IoT device 200B as shown in FIG. 2B, the logic configured to receive local user input 325 can include the buttons 222, 224A, and 224B, the display 226 (if a touchscreen), etc. In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

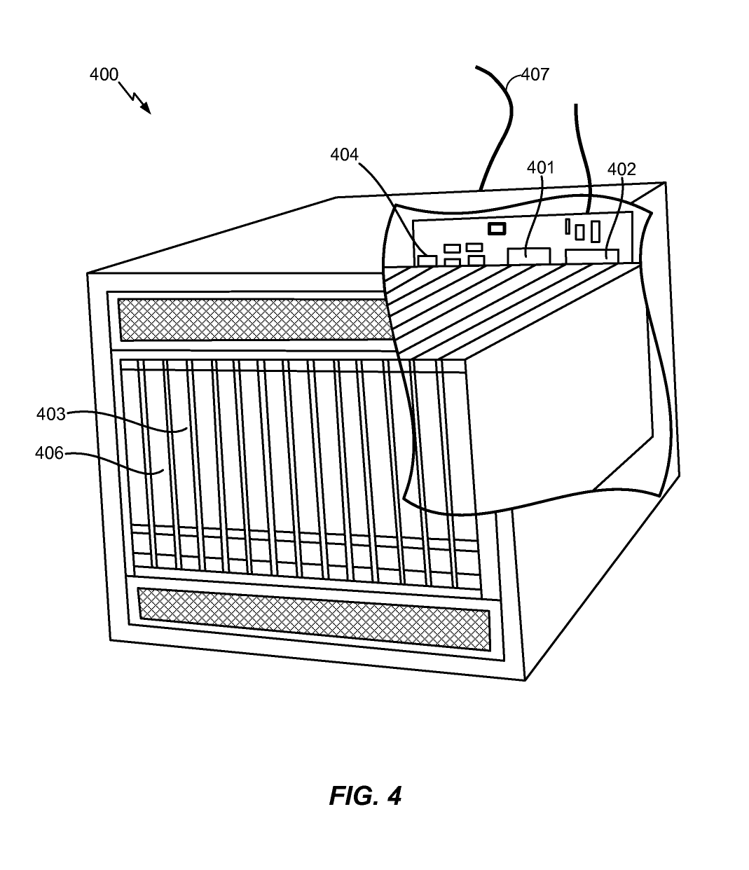

The various embodiments may be implemented on any of a variety of commercially available server devices, such as server 400 illustrated in FIG. 4. In an example, the server 400 may correspond to one example configuration of the IoT server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access points 404 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to an IoT device implementation as in FIG. 2A.

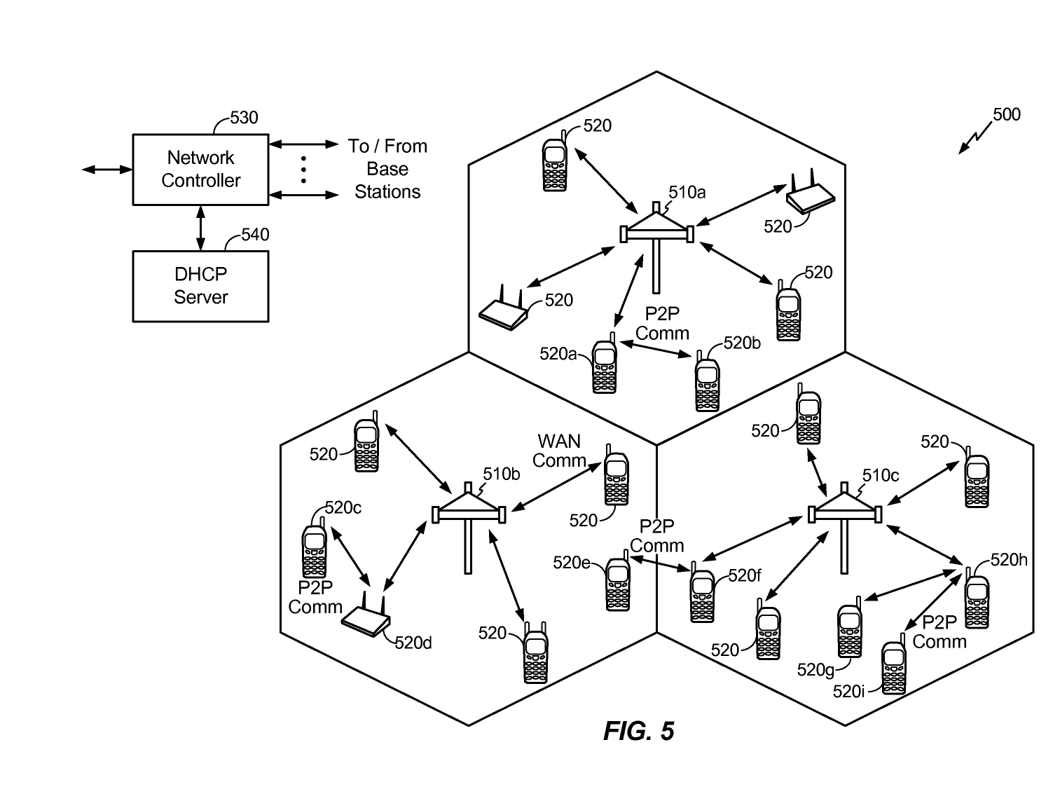

In general, user equipment (UE) such as telephones, tablet computers, laptop and desktop computers, certain vehicles, etc., can be configured to connect with each other either locally (e.g., Bluetooth, local Wi-Fi, etc.) or remotely (e.g., via cellular networks, through the Internet, etc.). Furthermore, certain UEs may also support proximity-based peer-to-peer (P2P) communication using certain wireless networking technologies (e.g., Wi-Fi, Bluetooth, Wi-Fi Direct, etc.) that enable devices to make a one-to-one connection or simultaneously connect to a group that includes several devices in order to directly communicate with one another. To that end, FIG. 5 illustrates an exemplary wireless communication network or WAN 500 that may support discoverable P2P services. For example, in one embodiment, the wireless communication network 500 may comprise an LTE network or another suitable WAN that includes various base stations 510 and other network entities. For simplicity, only three base stations 510a, 510b and 510c, one network controller 530, and one Dynamic Host Configuration Protocol (DHCP) server 540 are shown in FIG. 5. A base station 510 may be an entity that communicates with devices 520 and may also be referred to as a Node B, an evolved Node B (eNB), an access point, etc. Each base station 510 may provide communication coverage for a particular geographic area and may support communication for the devices 520 located within the coverage area. To improve network capacity, the overall coverage area of a base station 510 may be partitioned into multiple (e.g., three) smaller areas, wherein each smaller area may be served by a respective base station 510. In 3GPP, the term “cell” can refer to a coverage area of a base station 510 and/or a base station subsystem 510 serving this coverage area, depending on the context in which the term is used. In 3GPP2, the term “sector” or “cell-sector” can refer to a coverage area of a base station 510 and/or a base station subsystem 510 serving this coverage area. For clarity, the 3GPP concept of “cell” may be used in the description herein.

A base station 510 may provide communication coverage for a macro cell, a pico cell, a femto cell, and/or other cell types. A macro cell may cover a relatively large geographic area (e.g., several kilometers in radius) and may allow unrestricted access by devices 520 with service subscription. A pico cell may cover a relatively small geographic area and may allow unrestricted access by devices 520 with service subscription. A femto cell may cover a relatively small geographic area (e.g., a home) and may allow restricted access by devices 520 having association with the femto cell (e.g., devices 520 in a Closed Subscriber Group (CSG)). In the example shown in FIG. 5, wireless network 500 includes macro base stations 510a, 510b and 510c for macro cells. Wireless network 500 may also include pico base stations 510 for pico cells and/or home base stations 510 for femto cells (not shown in FIG. 5).

Network controller 530 may couple to a set of base stations 510 and may provide coordination and control for these base stations 510. Network controller 530 may be a single network entity or a collection of network entities that can communicate with the base stations via a backhaul. The base stations may also communicate with one another, e.g., directly or indirectly via wireless or wireline backhaul. DHCP server 540 may support P2P communication, as described below. DHCP server 540 may be part of wireless network 500, external to wireless network 500, run via Internet Connection Sharing (ICS), or any suitable combination thereof. DHCP server 540 may be a separate entity (e.g., as shown in FIG. 5) or may be part of a base station 510, network controller 530, or some other entity. In any case, DHCP server 540 may be reachable by devices 520 desiring to communicate peer-to-peer.

Devices 520 may be dispersed throughout wireless network 500, and each device 520 may be stationary or mobile. A device 520 may also be referred to as a node, user equipment (UE), a station, a mobile station, a terminal, an access terminal, a subscriber unit, etc. A device 520 may be a cellular phone, a personal digital assistant (PDA), a wireless modem, a wireless communication device, a handheld device, a laptop computer, a cordless phone, a wireless local loop (WLL) station, a smart phone, a netbook, a smartbook, a tablet, etc. A device 520 may communicate with base stations 510 in the wireless network 500 and may further communicate peer-to-peer with other devices 520. For example, as shown in FIG. 5, devices 520a and 520b may communicate peer-to-peer, devices 520c and 520d may communicate peer-to-peer, devices 520e and 520f may communicate peer-to-peer, and devices 520g, 520h, and 520i may communicate peer-to-peer, while remaining devices 520 may communicate with base stations 510. As further shown in FIG. 5, devices 520a, 520d, 520f, and 520h may also communicate with base stations 500, e.g., when not engaged in P2P communication or possibly concurrent with P2P communication.

In the description herein, WAN communication may refer to communication between a device 520 and a base station 510 in wireless network 500, e.g., for a call with a remote entity such as another device 520. A WAN device is a device 520 that is interested or engaged in WAN communication. P2P communication refers to direct communication between two or more devices 520, without going through any base station 510. A P2P device is a device 520 that is interested or engaged in P2P communication, e.g., a device 520 that has traffic data for another device 520 within proximity of the P2P device. Two devices may be considered to be within proximity of one another, for example, if each device 520 can detect the other device 520. In general, a device 520 may communicate with another device 520 either directly for P2P communication or via at least one base station 510 for WAN communication.

In one embodiment, direct communication between P2P devices 520 may be organized into P2P groups. More particularly, a P2P group generally refers to a group of two or more devices 520 interested or engaged in P2P communication and a P2P link refers to a communication link for a P2P group. Furthermore, in one embodiment, a P2P group may include one device 520 designated a P2P group owner (or a P2P server) and one or more devices 520 designated P2P clients that are served by the P2P group owner. The P2P group owner may perform certain management functions such as exchanging signaling with a WAN, coordinating data transmission between the P2P group owner and P2P clients, etc. For example, as shown in FIG. 5, a first P2P group includes devices 520a and 520b under the coverage of base station 510a, a second P2P group includes devices 520c and 520d under the coverage of base station 510b, a third P2P group includes devices 520e and 520f under the coverage of different base stations 510b and 510c, and a fourth P2P group includes devices 520g, 520h and 520i under the coverage of base station 510c. Devices 520a, 520d, 520f, and 520h may be P2P group owners for their respective P2P groups and devices 520b, 520c, 520e, 520g, and 520i may be P2P clients in their respective P2P groups. The other devices 520 in FIG. 5 may be engaged in WAN communication.

In one embodiment, P2P communication may occur only within a P2P group and may further occur only between the P2P group owner and the P2P clients associated therewith. For example, if two P2P clients within the same P2P group (e.g., devices 520g and 520i) desire to exchange information, one of the P2P clients may send the information to the P2P group owner (e.g., device 520h) and the P2P group owner may then relay transmissions to the other P2P client. In one embodiment, a particular device 520 may belong to multiple P2P groups and may behave as either a P2P group owner or a P2P client in each P2P group. Furthermore, in one embodiment, a particular P2P client may belong to only one P2P group or belong to multiple P2P group and communicate with P2P devices 520 in any of the multiple P2P groups at any particular moment. In general, communication may be facilitated via transmissions on the downlink and uplink. For WAN communication, the downlink (or forward link) refers to the communication link from base stations 510 to devices 520, and the uplink (or reverse link) refers to the communication link from devices 520 to base stations 510. For P2P communication, the P2P downlink refers to the communication link from P2P group owners to P2P clients and the P2P uplink refers to the communication link from P2P clients to P2P group owners. In certain embodiments, rather than using WAN technologies to communicate P2P, two or more devices may form smaller P2P groups and communicate P2P on a wireless local area network (WLAN) using technologies such as Wi-Fi, Bluetooth, or Wi-Fi Direct. For example, P2P communication using Wi-Fi, Bluetooth, Wi-Fi Direct, or other WLAN technologies may enable P2P communication between two or more mobile phones, game consoles, laptop computers, or other suitable communication entities.

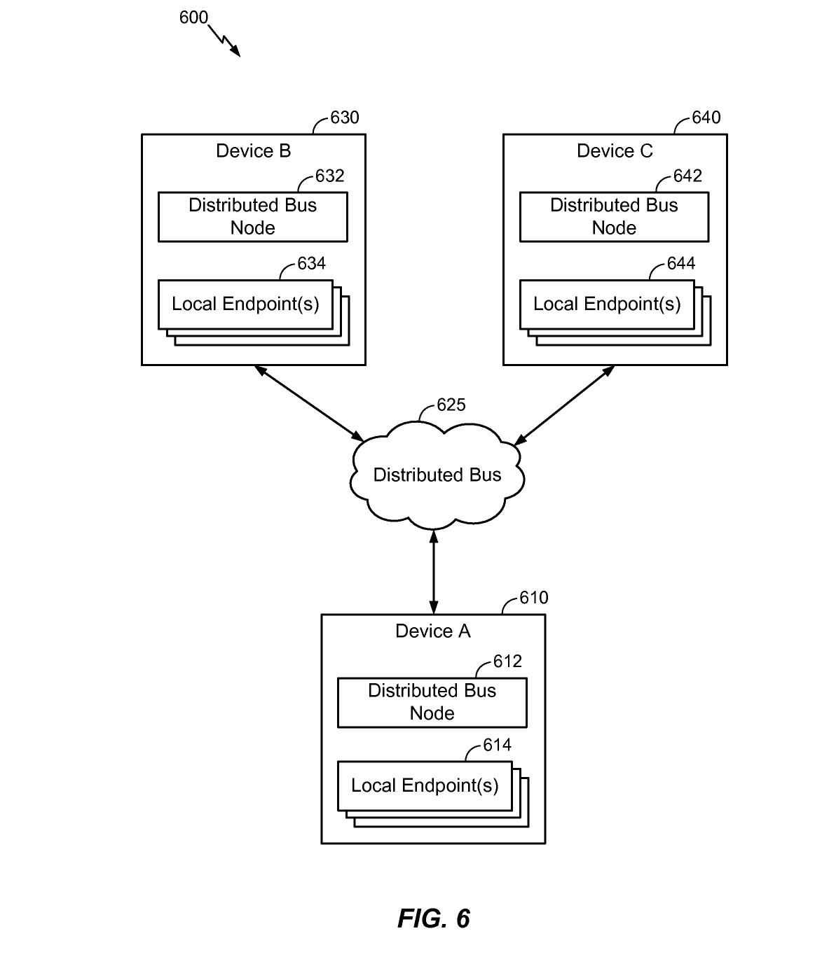

According to one aspect of the disclosure, FIG. 6 illustrates an exemplary environment 600 in which discoverable P2P services may be used to establish a proximity-based distributed bus over which various devices 610, 630, 640 may communicate. For example, in one embodiment, communications between applications and the like, on a single platform may be facilitated using an interprocess communication protocol (IPC) framework over the distributed bus 625, which may comprise a software bus used to enable application-to-application communications in a networked computing environment where applications register with the distributed bus 625 to offer services to other applications and other applications query the distributed bus 625 for information about registered applications. Such a protocol may provide asynchronous notifications and remote procedure calls (RPCs) in which signal messages (e.g., notifications) may be point-to-point or broadcast, method call messages (e.g., RPCs) may be synchronous or asynchronous, and the distributed bus 625 (e.g., a “daemon” bus process) may handle message routing between the various devices 610, 630, 640.

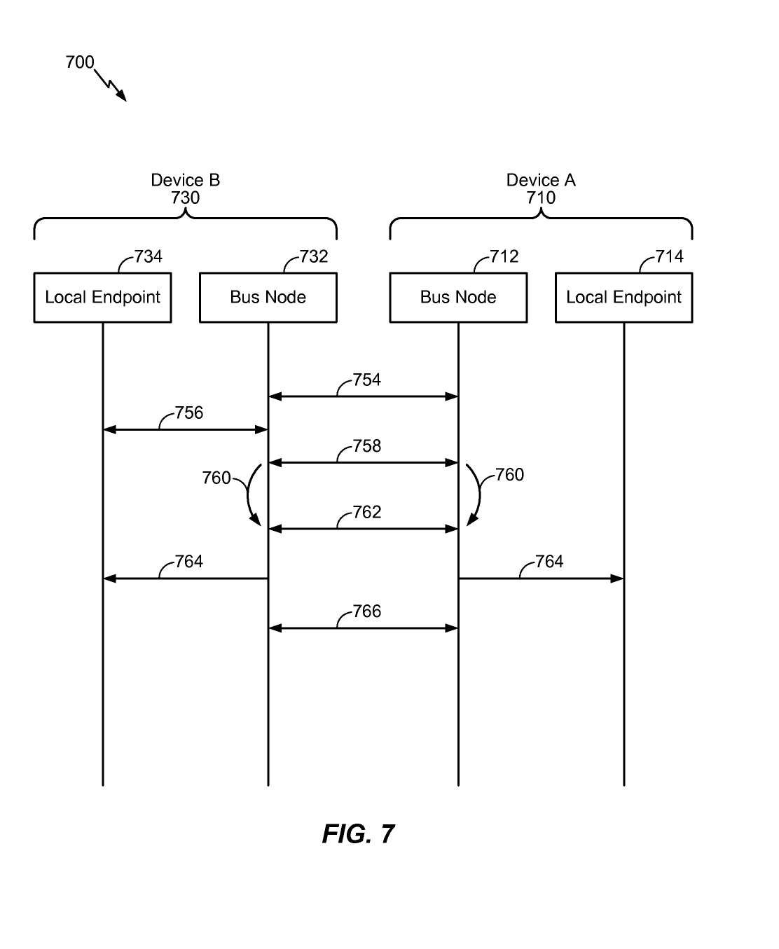

In one embodiment, the distributed bus 625 may be supported by a variety of transport protocols (e.g., Bluetooth, TCP/IP, Wi-Fi, CDMA, GPRS, UMTS, etc.). For example, according to one aspect, a first device 610 may include a distributed bus node 612 and one or more local endpoints 614, wherein the distributed bus node 612 may facilitate communications between local endpoints 614 associated with the first device 610 and local endpoints 634 and 644 associated with a second device 630 and a third device 640 through the distributed bus 625 (e.g., via distributed bus nodes 632 and 642 on the second device 630 and the third device 640). As will be described in further detail below with reference to FIG. 7, the distributed bus 625 may support symmetric multi-device network topologies and may provide a robust operation in the presence of device drops-outs. As such, the virtual distributed bus 625, which may generally be independent from any underlying transport protocol (e.g., Bluetooth, TCP/IP, Wi-Fi, etc.) may allow various security options, from unsecured (e.g., open) to secured (e.g., authenticated and encrypted), wherein the security options can be used while facilitating spontaneous connections with among the first device 610, the second device 630, and the third device 640 without intervention when the various devices 610, 630, 640 come into range or proximity to each other.

According to one aspect of the disclosure, FIG. 7 illustrates an exemplary message sequence 700 in which discoverable P2P services may be used to establish a proximity-based distributed bus over which a first device (“Device A”) 710 and a second device (“Device B”) 730 may communicate. Generally, Device A 710 may request to communicate with Device B 730, wherein Device A 710 may a include local endpoint 714 (e.g., a local application, service, etc.), which may make a request to communicate in addition to a bus node 712 that may assist in facilitating such communications. Further, Device B 730 may include a local endpoint 734 with which the local endpoint 714 may be attempting to communicate in addition to a bus node 732 that may assist in facilitating communications between the local endpoint 714 on the Device A 710 and the local endpoint 734 on Device B 730.

In one embodiment, the bus nodes 712 and 732 may perform a suitable discovery mechanism at message sequence step 754. For example, mechanisms for discovering connections supported by Bluetooth, TCP/IP, UNIX, or the like may be used. At message sequence step 756, the local endpoint 714 on Device A 710 may request to connect to an entity, service, endpoint etc., available through bus node 712. In one embodiment, the request may include a request-and-response process between local endpoint 714 and bus node 712. At message sequence step 758, a distributed message bus may be formed to connect bus node 712 to bus node 732 and thereby establish a P2P connection between Device A 710 and Device B 730. In one embodiment, communications to form the distributed bus between the bus nodes 712 and 732 may be facilitated using a suitable proximity-based P2P protocol (e.g., the AllJoyn™ software framework designed to enable interoperability among connected products and software applications from different manufacturers to dynamically create proximal networks and facilitate proximal P2P communication). Alternatively, in one embodiment, a server (not shown) may facilitate the connection between the bus nodes 712 and 732. Furthermore, in one embodiment, a suitable authentication mechanism may be used prior to forming the connection between bus nodes 712 and 732 (e.g., SASL authentication in which a client may send an authentication command to initiate an authentication conversation). Still further, during message sequence step 758, bus nodes 712 and 732 may exchange information about other available endpoints (e.g., local endpoints 644 on Device C 640 in FIG. 6). In such embodiments, each local endpoint that a bus node maintains may be advertised to other bus nodes, wherein the advertisement may include unique endpoint names, transport types, connection parameters, or other suitable information.

In one embodiment, at message sequence step 760, bus node 712 and bus node 732 may use obtained information associated with the local endpoints 734 and 714, respectively, to create virtual endpoints that may represent the real obtained endpoints available through various bus nodes. In one embodiment, message routing on the bus node 712 may use real and virtual endpoints to deliver messages. Further, there may one local virtual endpoint for every endpoint that exists on remote devices (e.g., Device A 710). Still further, such virtual endpoints may multiplex and/or de-multiplex messages sent over the distributed bus (e.g., a connection between bus node 712 and bus node 732). In one aspect, virtual endpoints may receive messages from the local bus node 712 or 732, just like real endpoints, and may forward messages over the distributed bus. As such, the virtual endpoints may forward messages to the local bus nodes 712 and 732 from the endpoint multiplexed distributed bus connection. Furthermore, in one embodiment, virtual endpoints that correspond to virtual endpoints on a remote device may be reconnected at any time to accommodate desired topologies of specific transport types. In such an aspect, UNIX based virtual endpoints may be considered local and as such may not be considered candidates for reconnection. Further, TCP-based virtual endpoints may be optimized for one hop routing (e.g., each bus node 712 and 732 may be directly connected to each other). Still further, Bluetooth-based virtual endpoints may be optimized for a single pico-net (e.g., one master and n slaves) in which the Bluetooth-based master may be the same bus node as a local master node.

At message sequence step 762, the bus node 712 and the bus node 732 may exchange bus state information to merge bus instances and enable communication over the distributed bus. For example, in one embodiment, the bus state information may include a well-known to unique endpoint name mapping, matching rules, routing group, or other suitable information. In one embodiment, the state information may be communicated between the bus node 712 and the bus node 732 instances using an interface with local endpoints 714 and 734 communicating with using a distributed bus based local name. In another aspect, bus node 712 and bus node 732 may each may maintain a local bus controller responsible for providing feedback to the distributed bus, wherein the bus controller may translate global methods, arguments, signals, and other information into the standards associated with the distributed bus. At message sequence step 764, the bus node 712 and the bus node 732 may communicate (e.g., broadcast) signals to inform the respective local endpoints 714 and 734 about any changes introduced during bus node connections, such as described above. In one embodiment, new and/or removed global and/or translated names may be indicated with name owner changed signals. Furthermore, global names that may be lost locally (e.g., due to name collisions) may be indicated with name lost signals. Still further, global names that are transferred due to name collisions may be indicated with name owner changed signals and unique names that disappear if and/or when the bus node 712 and the bus node 732 become disconnected may be indicated with name owner changed signals.

As used above, well-known names may be used to uniquely describe local endpoints 714 and 734. In one embodiment, when communications occur between Device A 710 and Device B 730, different well-known name types may be used. For example, a device local name may exist only on the bus node 712 associated with Device A 710 to which the bus node 712 directly attaches. In another example, a global name may exist on all known bus nodes 712 and 732, where only one owner of the name may exist on all bus segments. In other words, when the bus node 712 and bus node 732 are joined and any collisions occur, one of the owners may lose the global name. In still another example, a translated name may be used when a client is connected to other bus nodes associated with a virtual bus. In such an aspect, the translated name may include an appended end (e.g., a local endpoint 714 with well-known name “org.foo” connected to the distributed bus with Globally Unique Identifier “1234” may be seen as “G1234.org.foo”).

At message sequence step 766, the bus node 712 and the bus node 732 may communicate (e.g., broadcast) signals to inform other bus nodes of changes to endpoint bus topologies. Thereafter, traffic from local endpoint 714 may move through virtual endpoints to reach intended local endpoint 734 on Device B 730. Further, in operation, communications between local endpoint 714 and local endpoint 734 may use routing groups. In one aspect, routing groups may enable endpoints to receive signals, method calls, or other suitable information from a subset of endpoints. As such, a routing name may be determined by an application connected to a bus node 712 or 732. For example, a P2P application may use a unique, well-known routing group name built into the application. Further, bus nodes 712 and 732 may support registering and/or de-registering of local endpoints 714 and 734 with routing groups. In one embodiment, routing groups may have no persistence beyond a current bus instance. In another aspect, applications may register for their preferred routing groups each time they connect to the distributed bus. Still further, groups may be open (e.g., any endpoint can join) or closed (e.g., only the creator of the group can modify the group). Yet further, a bus node 712 or 732 may send signals to notify other remote bus nodes or additions, removals, or other changes to routing group endpoints. In such embodiments, the bus node 712 or 732 may send a routing group change signal to other group members whenever a member is added and/or removed from the group. Further, the bus node 712 or 732 may send a routing group change signal to endpoints that disconnect from the distributed bus without first removing themselves from the routing group.

In general, because the increasing development in IoT technologies will lead to numerous IoT devices surrounding users in their homes, vehicles, workplaces, and many other locations, IoT technologies may provide opportunities to offer a joint purchasing service through which consumers or other parties may buy products or services jointly and thereby limit the cost to each joint purchaser, and further though which jointly purchased products and services can be tracked and managed to ensure that ownership distributions over the jointly purchased products and services are properly maintained. Furthermore, in certain use cases, as will be described in further detail below, the jointly purchased products and services may be managed using a proximity-based peer-to-peer protocol (e.g., to ensure that various concurrent joint purchasers are located in proximity to one another and thereby maintain a concurrent ownership distribution among the joint purchasers).

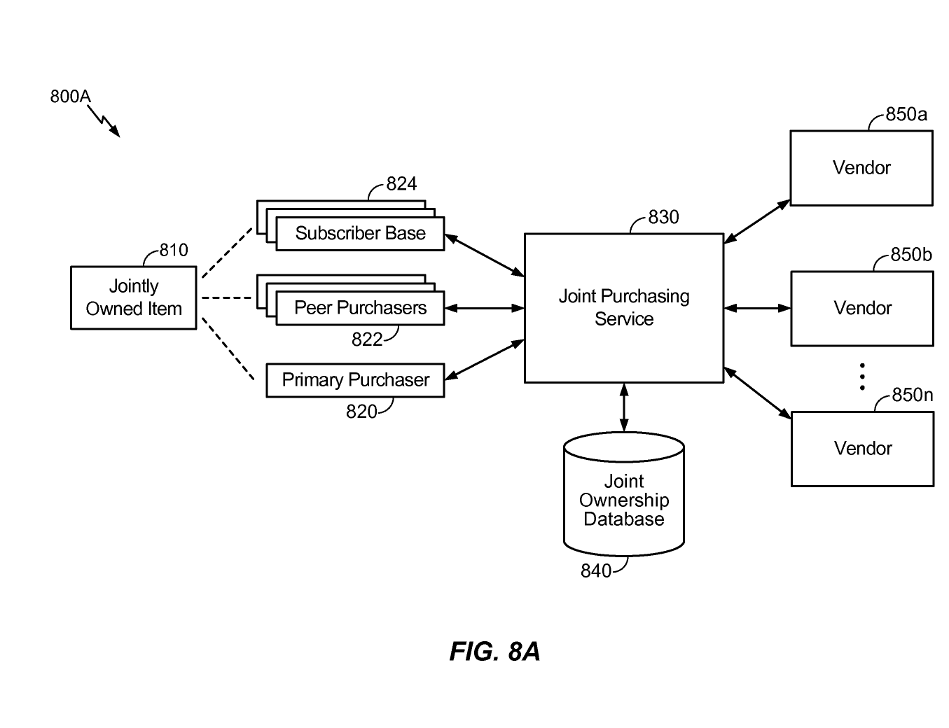

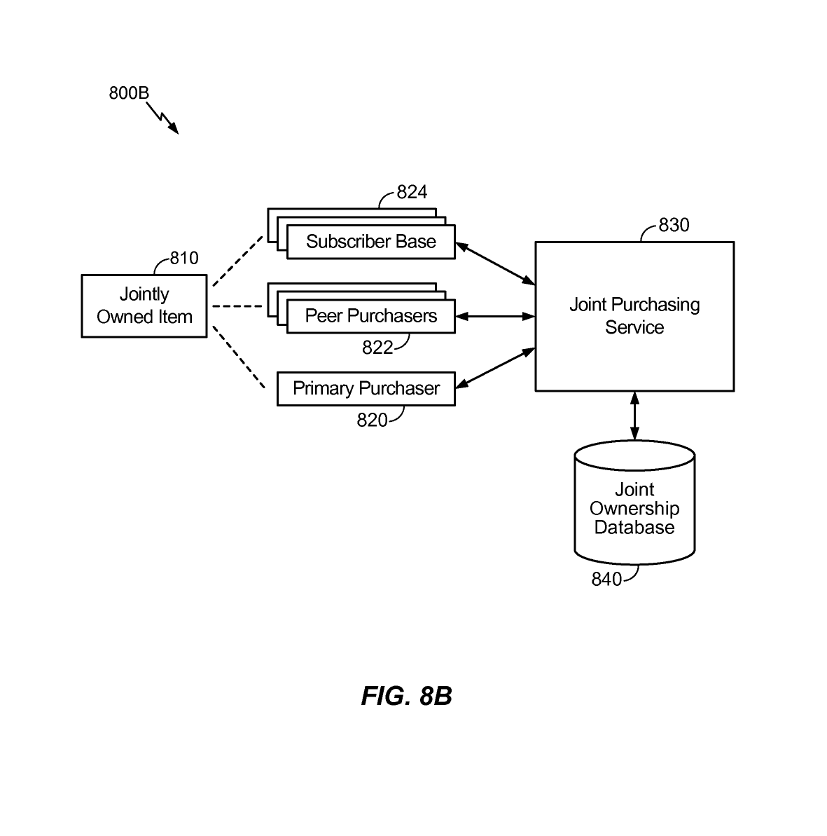

More particularly, according to one aspect of the disclosure, FIG. 8A illustrates an exemplary system 800A that may be used to facilitate a joint purchase among multiple parties and track a joint purchase ownership distribution among the multiple parties to the joint purchase. In one embodiment, a primary purchaser 820 interested in purchasing one or more products or services offered for sale through a particular vendor (e.g., vendor 850a, 850b, 850n, etc.) may interact with a third-party joint purchasing service 830, which may provide an intermediary between the primary purchaser 820 and the vendor 850 offering to sell the one or more products or services in order to enable the primary purchaser 820 to share the cost and ownership associated with the products or services with one or more additional users. For example, in one embodiment, the joint purchasing service 830 may provide the primary purchaser 820 with an option to solicit one or more peer purchasers 822 from a peer network associated with the primary purchaser 820, wherein the peer purchasers 822 may be identified based on contacts that the primary purchaser 820 has stored in a mobile phone or other suitable contact list, friends that the primary purchaser 820 has in one or more social networks, or other peer purchasers 822 that the primary purchaser 820 may suitably identify (e.g., according to manually entered contact information). In another example, the joint purchasing service 830 may provide the primary purchaser 820 with an option to solicit joint purchasers from a subscriber base 824 associated with the joint purchasing service 830, wherein the joint purchasing service 830 may then offer the products or services in question to the subscriber base 824, specify any applicable restrictions upon interested parties, and allow interested buyers to take part in the joint purchase. For example, a primary purchaser 820 living in Des Moines, Iowa may want to buy a high chair that the vendor 850 offers for sale and split the purchase with another buyer in an arrangement whereby the primary purchaser 820 can use the high chair for six months period and a joint purchaser can then use the high chair for the next six months. In this example, the joint purchasing service 830 may offer the high chair to potential buyers in the subscriber base 824 with the stipulation that any potential joint purchaser allow the primary purchaser 820 to use the high chair for the first six months and with the understanding that the potential joint purchaser live in reasonable proximity to Des Moines, Iowa or be able to make reasonable arrangements to travel to Des Moines, Iowa such that the joint purchaser would be able to pick up the high chair in six months.

In one embodiment, once the primary purchaser 820 has suitably identified the one or more peer purchasers 822 interested in splitting the cost and sharing in the ownership associated with the products or services and/or the joint purchasing service 830 has found one or more joint purchasers in the subscriber base 824 that are interested in splitting the cost and sharing in the ownership associated with the products or services, the joint purchasing service 830 may then communicate with the appropriate vendor 850 offering to sell the products or services to complete the joint purchase. The joint purchasing service 830 may receive credit card information or other billing details from the primary purchaser 820, any peer purchasers 822 that the primary purchaser 820 solicited who agreed to participate in the joint purchase, and/or any joint purchasers that were found from the subscriber base 824 and then appropriately split the cost associated with the joint purchase among the various joint purchasers according to any agreed-upon ownership distribution. For example, the joint purchasers may agree upon a consecutive ownership distribution schedule in which each joint purchaser takes possession and uses a jointly owned item 810 for a particular time period, in which case the cost associated with the jointly owned item 810 may be evenly divided among the various joint purchasers. In another example, the joint purchasers may agree upon a concurrent ownership distribution schedule in which each joint purchaser can possess and use the jointly owned item 810 subject to a certain percentage or proportion, wherein the cost associated with the jointly owned item 810 may be split among the various joint purchasers according to the percentage or proportion allocated to each joint purchaser.

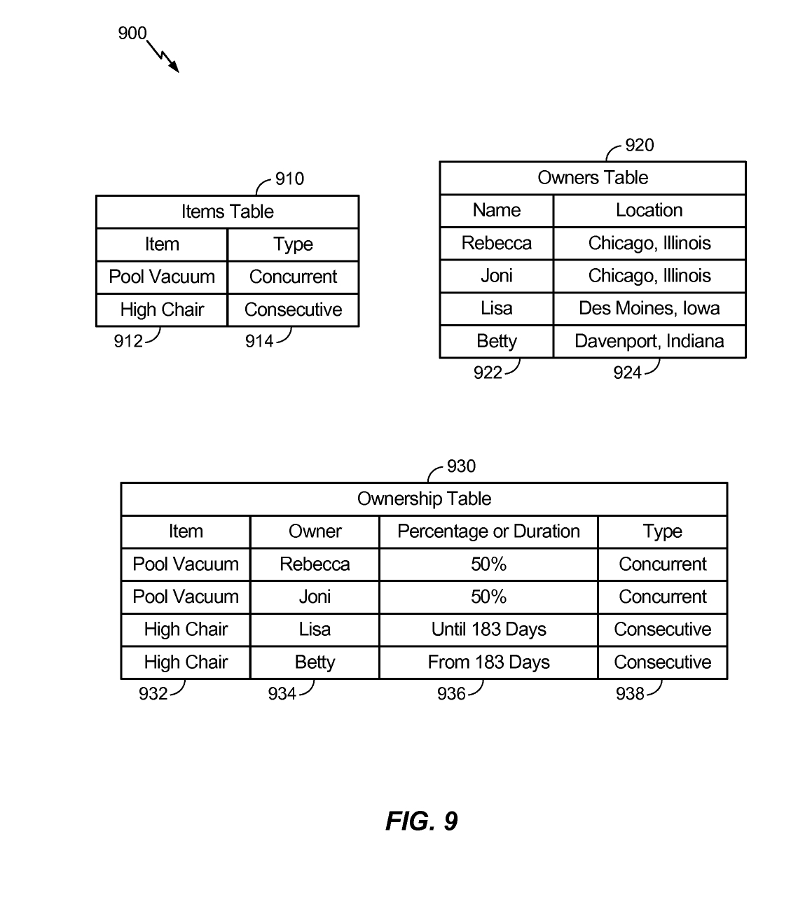

In one embodiment, the joint purchasing service 830 may therefore maintain a joint ownership database 840 to track the ownership distributions according to a user-determined distribution (e.g., a distribution that the joint purchasers agree upon in advance), according to a system-determined distribution (e.g., a distribution that may depend on usage statistics or other suitable system-determined information), or any suitable combination thereof. For example, referring to FIG. 9, an exemplary database 900 that may correspond to the joint ownership database 840 shown in FIG. 8A may include an Items Table 910, an Owners Table 920, and an Ownership Table 930 that can be used to facilitate a joint purchase among multiple parties and track a joint purchase ownership distribution among the multiple parties to the joint purchase. As shown in FIG. 9, the Items Table 910 may include an Item field 912 that lists various jointly owned items managed through the joint purchasing service 830 and a Type 912 that indicates the ownership distribution type associated therewith (e.g., concurrent or consecutive). Furthermore, the Owners Table 920 may include a Name field 922 that lists various users that have jointly purchased one or more items 912 through the joint purchasing service 830 in addition to a Location field 924 that indicates where the joint purchasers live or other preferred locations that the joint purchasers may specify (e.g., certain joint purchasers may jointly purchase an item to use in their workplace and therefore specify a work location rather than a home location). Accordingly, the Ownership Table 930 may generally include an Item field 932, an Owner field 934, a Percentage or Duration field 936, and a Type field 938, wherein each row in the Ownership Table 930 may indicate a jointly owned item, a particular joint owner associated with the jointly owned item, a percentage or duration of the ownership allocated to the particular joint owner, and the type of ownership distribution associated with the jointly owned item. Accordingly, in one embodiment, the joint purchasing service 830 may feed the ownership distribution information tracked in the ownership database 840, 900 into a billing system to ensure that each joint purchaser can be billed appropriately.

Furthermore, in one embodiment, the joint purchasing service 830 may provide an application or other suitable user interface (not shown) that the joint purchasers may use to view the ownership distribution information tracked in the ownership database 840, 900 or other information relevant to the jointly owned item 810 (e.g., jointly owned items 810 associated with a particular user, information relating to locations, usage statistics, or other state data relating to jointly owned items 810 associated with the user, parties currently possessing jointly owned items 810 associated with the user, how long parties currently possessing jointly owned items 810 subject to a consecutive ownership distribution are scheduled to possess the jointly owned items 810, whether joint purchasers over jointly owned items 810 subject to a concurrent ownership distribution have exceeded a possession or usage proportion allocated thereto, etc.).

According to one aspect of the disclosure, FIG. 8B illustrates another exemplary system 800B that may be used to facilitate a joint purchase among multiple parties and track a joint purchase ownership distribution among the multiple parties to the joint purchase. In general, the system 800B shown in FIG. 8B may be substantially similar to the system 800A shown in FIG. 8A and described in further detail above, except that the system 800B shown in FIG. 8B may include a vendor 850 that offers the joint purchasing service for one or more products or services that the vendor 850 offers for sale, whereby the vendor 850 may provide the functionality that can otherwise be offered through the third-party joint purchasing service 820 as shown in FIG. 8A. As such, for brevity and to simplify the description provided herein in relation to how the vendor 850 may offer the joint purchasing service, various details relating to certain components, functionality, or other aspects associated with the system 800B shown in FIG. 8B may be omitted herein to the extent that the same or similar details have already been provided above in relation to the system 800A shown in FIG. 8A.

In one embodiment, the joint purchasing service offered through the vendor 850 may similarly allow the primary purchaser 820 to solicit peer purchasers 822 from the peer network associated with the primary purchaser 820 based on contacts that the primary purchaser 820 has stored in a mobile phone or other suitable contact list, friends that the primary purchaser 820 has in one or more social networks, or other suitable information. For example, the vendor 850 may provide an “Enlist Friends” button or other suitable option in connection with products or services eligible for the joint purchasing service. As such, in response to the primary purchaser 820 selecting the joint purchasing service option, the primary purchaser 820, upon checkout, may input details associated with different credit cards associated with the peer purchasers 822 that the primary purchaser 820 solicited and who have agreed to split the purchase, and the vendor 850 may implement one or more appropriate security controls to confirm that the peer purchasers 822 have indeed agreed to pay. For example, in one embodiment, the vendor 850 may require that each peer purchaser 822 to provide certain details to authenticate the credit card information that the primary purchaser 820 provided. In another example, each peer purchaser 822 participating in the joint purchase may be required to input their own credit card information to split the purchase. For example, the primary purchaser 820 may provide the vendor 850 with email addresses associated with each peer purchaser 822 and the vendor 850 may then send a link to each peer purchasers 822 upon being alerted to the requested joint purchase details and require each peer purchaser 822 to input their credit card information and specify the split balance that each peer purchaser 822 agrees to pay. Alternatively, the vendor 850 may similarly provide the primary purchaser 820 with the option to solicit joint purchasers from a subscriber base 824 associated with the vendor 850 and thereby offer the joint purchase to various customers, subject to any restrictions or other stipulations upon interested parties based on the nature of each individual purchase. Accordingly, the vendor 850 may similarly maintain a joint ownership database 840 to track the ownership distributions feed the tracked ownership distribution into a billing system to ensure that each joint purchaser can be billed appropriately.

In one embodiment, as noted above, the ownership distribution information stored in joint ownership database 840 may be tracked according to user-determined distributions (e.g., consecutive or concurrent ownership distributions that the joint purchasers agree upon in advance), according to system-determined distributions (e.g., consecutive or concurrent distributions that depend on usage statistics or other system-determined information), or any suitable combination thereof. As such, the third-party joint purchasing service 830 and/or the vendor 850 that provides and maintains the joint ownership database 840 may track the information stored therein to maintain the proper ownership distribution among multiple parties that have agreed to share ownership in a particular jointly owned item 810.

For example, in one embodiment, the multiple parties may have agreed to a consecutive ownership distribution in which a first joint purchaser will initially possess and use the jointly owned item 810 for an initial time period and then transfer possession to a second joint purchaser who can then possess and use the jointly owned item 810 for another time period, which may be the same as or different from the initial time period depending on the agreement among the multiple parties, wherein the right to possess and use the jointly owned item 810 may continue to be transferred to any additional joint purchasers according to the consecutive ownership distribution schedule. In another exemplary use case, at some point in time the right to possess and use the jointly owned item 810 may revert to the first joint purchaser. Furthermore, those skilled in the art will appreciate that the consecutive ownership distribution schedule may define various sequences and time periods according to which the right to possess and use the jointly owned item 810 may be transferred among the multiple parties to the joint purchase. In one embodiment, in order to track and maintain the consecutive ownership distribution schedule, the jointly owned item 810 may be tracked using GPS technology or other suitable mechanisms to determine a current location associated therewith. For example, referring to FIGS. 1A-1E, the jointly owned item 810 may comprise an IoT device (e.g., a pool vacuum) that can be tracked in an appropriate IoT environment that can detect the presence of the jointly owned item 810, monitor usage statistics associated with the jointly owned item 810, or otherwise track the state associated with the jointly owned item 810 (e.g., a change from an unused state to an in-use state may reflect that a particular joint purchaser is using the jointly owned item 810 and the duration that the jointly owned item 810 remains in the in-use state may indicate how long the particular joint purchaser has been using the jointly owned item 810).

As such, in the consecutive ownership distribution context, the current location associated with the jointly owned item 810 may be tracked and fed into the joint ownership database 840 (e.g., via a supervisor, an IoT SuperAgent, or another suitable entity that may manage a relevant IoT environment) and used to determine whether the time period allocated to the joint purchaser currently possessing the jointly owned item 810 has expired. Accordingly, when the time period allocated to the currently possessing joint purchaser has expired, an appropriate notification (e.g., an email, text message, etc.) may be sent to the currently possessing joint purchaser and the next joint purchaser scheduled to take possession in order to remind the current and next joint purchaser that it is now the next joint purchaser's turn to possess and use the jointly owned item 810. Additionally, in one embodiment, notifications may be sent to the current and next joint purchaser at some point prior to when the possession period allocated to the current joint purchaser expires in order to enable the current and next joint purchaser to make appropriate arrangements to transfer possession when the current possession period eventually expires. Furthermore, the current location associated with the jointly owned item 810 may continue to be tracked to confirm whether possession was indeed transferred from the current joint purchaser to the next joint purchaser and additional notifications may be sent until the transfer in possession can be appropriately confirmed. Alternatively, if the jointly owned item 810 comprises an electronic item (e.g., a song, movie, etc.), the jointly owned electronic item 810 may be automatically transferred from the current joint purchaser to the next joint purchaser after the possession period allocated to the current joint purchaser has expired, and an appropriate notification may optionally be sent to the current and next joint purchasers to indicate that the transfer occurred.

In another embodiment, where the multiple parties agree to a concurrent ownership distribution, each joint purchaser may have the right to possess and use the jointly owned item 810 at any particular time subject to a certain percentage or proportion allocated to each joint purchaser. For example, in one exemplary use case, a first joint purchaser may be assigned 50% of the concurrent ownership distribution, a second joint purchaser may be assigned 25% of the concurrent ownership distribution, and a third joint purchaser may be assigned the remaining 25% of the concurrent ownership distribution. As such, the location, usage, state, or other suitable information associated with the jointly owned item 810 may be tracked in a similar manner as in the consecutive ownership context mentioned above to determine the particular joint purchaser possessing and using the jointly owned item 810 at any particular time and the duration associated with any such possession and use, wherein the tracked possession and use may be compared to the agreed-upon concurrent ownership distribution to determine whether the actual possession and use shared among the various joint purchasers conforms to the agreed-upon percentages or proportions. In response to a determination that the actual possession and use has deviated from the agreed-upon percentages or proportions (e.g., the first joint purchaser has possessed and used the jointly owned item 810 for several days without the second or third joint purchasers having a turn to possess and use the jointly owned item 810), a notification may be sent to the various joint purchasers to indicate the deviation from the concurrent ownership distribution schedule and allow the various joint purchasers to remedy the situation. Otherwise, if the actual possession and use conforms to the agreed-upon percentages or proportions, the location, usage, or other state information associated with the jointly owned item 810 may continue to be tracked and periodically checked against the agreed-upon concurrent ownership distribution to ensure that the joint purchasers are continuing to maintain the proper distribution.

In another exemplary embodiment, where the jointly owned item 810 comprises an electronic item subject to a concurrent ownership distribution, usage associated with the jointly owned electronic item 810 may be constrained to ensure that the various joint purchasers can only use the jointly owned electronic item 810 concurrently (e.g., when the various users are located in proximity to one another). In one embodiment, to ensure that the various users are located in proximity to one another and thereby control concurrent use over the jointly owned electronic item 810, a proximity-based peer-to-peer protocol may be used such that the jointly owned electronic item 810 can only be rendered when devices associated with the various users are located within sufficient proximity to establish a proximity-based distributed bus (e.g., according to the mechanisms associated with the proximity-based peer-to-peer protocol described in further detail above with respect to FIGS. 5-7). For example, the jointly owned electronic item 810 may comprise a digital movie and portions thereof may be distributed among IoT devices associated with the various joint purchasers such that the full digital movie can only be assembled and rendered when all joint purchasers are proximally located and their devices are able to establish a proximal peer-to-peer connection. In another example, the full digital movie may require a license key or other suitable authentication credential to be provided prior to rendering, and portions of the authentication credential may be similarly distributed among the various joint purchasers such that the full authentication credential can only be assembled to enable rendering the digital movie when all joint purchasers are proximally located. In this case, the full digital movie may be provided to each joint purchaser and the authentication credential may provide the mechanism to ensure that the various joint purchasers can view the digital movie concurrently. However, portions of the jointly owned electronic item 810 may be similarly distributed among the various joint purchasers to provide an additional constraint on the concurrent use, if appropriate. Furthermore, those skilled in the art will appreciate that various other mechanisms may be used to ensure that the various joint purchasers are proximally located prior to enabling the jointly owned electronic item 810 to be appropriately rendered (e.g., the jointly owned electronic item 810 may be managed through a cloud service that can be used to stream the jointly owned electronic item 810 without being located on any joint purchaser's device and the cloud service may only allow the jointly owned electronic item 810 to be streamed in response to receiving information to confirm that all of the joint purchasers are located in suitable proximity to one another).

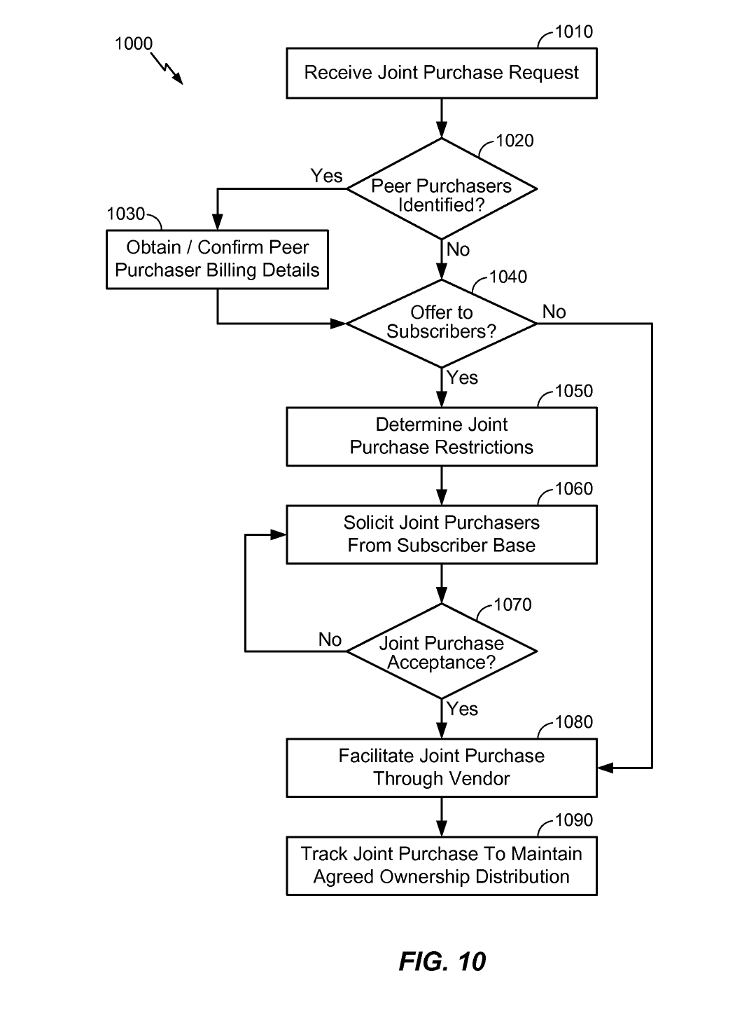

According to one aspect of the disclosure, FIG. 10 illustrates an exemplary method 1000 that may be used to facilitate a joint purchase among multiple parties and track a joint purchase ownership distribution among the multiple parties to the joint purchase. In particular, at block 1010, a joint purchase request may be received from a primary purchaser interested in purchasing one or more items from a particular vendor, wherein the joint purchase request may indicate that the primary purchaser wants to share the cost and ownership associated with the items with one or more additional users. Accordingly, at block 1020, a joint purchasing service may determine whether the primary purchaser has solicited one or more peer purchasers from a peer network, wherein the peer purchasers may be identified based on contacts that the primary purchaser has stored in a mobile phone or other suitable contact list, friends that the primary purchaser has in one or more social networks, or other peer purchasers that the primary purchaser may suitably identify (e.g., according to manually entered contact information). In one embodiment, in response to determining that the primary purchaser has identified one or more peer purchasers interested in splitting the cost and sharing in the ownership associated with the items, credit card information or other billing details associated with the peer purchasers may be obtained and/or confirmed at block 1030. For example, the primary purchaser may enter email addresses in addition to the credit card information or other billing details associated with the peer purchasers, wherein block 1030 may comprise sending a link to each peer purchasers upon being alerted to the requested joint purchase details to require each peer purchaser to confirm the billing details and to confirm that the identified peer purchasers have indeed agreed to pay. In another example, block 1030 may require each peer purchaser to input their own credit card information and specify the split balance that each peer purchaser has agreed to pay.

In one embodiment, at block 1040, the joint purchasing service may then determine whether the primary purchaser has requested joint purchasers from a subscriber base associated with the joint purchasing service, in which case the joint purchasing service may then determine any applicable restrictions upon interested parties at block 1050 and solicit joint purchasers from the subscriber base according to the determined restrictions at block 1060 to allow interested buyers to take part in the joint purchase. For example, the restrictions determined at block 1050 may specify that any potential joint purchaser be willing to allow the primary purchaser (and/or any previously identified peer purchasers) to use the jointly owned items for a certain time period before the joint purchaser solicited from the subscriber base will be permitted to use the jointly owned items. In another example, the restrictions determined at block 1050 may include a stipulation that any potential joint purchaser must live in reasonable proximity to the primary purchaser (and/or any previously identified peer purchasers) or otherwise be willing to make reasonable travel arrangements to take possession of the jointly owned item when their turn comes up. Accordingly, in response to determining that the joint purchase is to be offered to the subscriber base, one or more joint purchasers may be solicited from the subscriber base at block 1060 (subject to the restrictions determined at block 1050) until the joint purchasing service determines at block 1070 that a sufficient number of joint purchasers have accepted the joint purchase according to the specified restrictions. In one embodiment, in response to suitably identifying the one or more peer purchasers and/or finding one or more joint purchasers in the subscriber base that are interested in splitting the cost and sharing in the ownership associated with the items, the joint purchase may then be facilitated through the vendor at block 1080. For example, a third-party intermediary may provide the joint purchasing service and communicate with the vendor to facilitate the joint purchase at block 1080. In another example, the vendor may provide the joint purchasing service directly to consumers and thereby independently facilitate the joint purchase at block 1080.

In either case, the joint purchase may be completed according to an agreed-upon ownership distribution among the various parties, wherein the joint purchase may be tracked to maintain the agreed-upon ownership distribution at block 1090. For example, in one embodiment, the multiple parties may agree to a consecutive ownership distribution in which a first joint purchaser will initially possess and use the jointly owned items for an initial time period and then transfer possession to a second joint purchaser who can then possess and use the jointly owned item for another time period. As such, the jointly owned item may be tracked using GPS technology or other suitable mechanisms and the currently possessing joint purchaser and the next joint purchaser scheduled to take possession may be notified to transfer possession when the time period allocated to the joint purchaser currently possessing the jointly owned item has expired or at some time prior thereto. Alternatively, if the jointly owned item comprises an electronic item subject to a consecutive distribution, the jointly owned electronic item may be automatically transferred from the current joint purchaser to the next joint purchaser after the possession period allocated to the current joint purchaser has expired. In another embodiment, where the multiple parties agree to a concurrent ownership distribution, each joint purchaser may have the right to possess and use the jointly owned item at any particular time subject to a certain percentage or proportion allocated to each joint purchaser, wherein the location, usage, or other suitable state information associated with the jointly owned item may be tracked to ensure that jointly owned item is being shared among the various parties according to the agreed-upon percentages or proportions. As such, if the actual possession and use deviates from the agreed-upon percentages or proportions, a notification may be sent to the various parties to indicate the deviation from the concurrent ownership distribution schedule and allow the various joint purchasers to remedy the situation. In another exemplary embodiment, where the jointly owned item comprises an electronic item subject to concurrent ownership, usage associated with the jointly owned electronic item may be constrained to ensure that the various joint purchasers can only use the jointly owned electronic item concurrently (e.g., when the various users are located in proximity to one another), as described in further detail above. For example, in one embodiment, a proximity-based peer-to-peer protocol may be used such that the jointly owned electronic item can only be rendered when devices associated with the various users are located within sufficient proximity to establish a proximity-based distributed bus according to the mechanisms associated with the proximity-based peer-to-peer protocol described in further detail above with respect to FIGS. 5-7.

Furthermore, in one embodiment, the joint purchasing service may provide an application or other suitable user interface that may enable the joint purchasers to view information associated with the joint purchase tracked at block 1090. For example, in one embodiment, the joint purchasers may install the application on one or more devices that the joint purchasers own, communicate with the joint purchasing service over a suitable network connection to view the user interface (e.g., in a web browser), or otherwise use the application or other suitable user interface to view the ownership distribution information tracked at block 1090 or view other information relevant to the joint purchase (e.g., jointly purchased items associated with a particular user, information relating to locations, usage statistics, or other state data relating to jointly purchased items associated with the user, parties currently possessing jointly purchased items associated with the user, how long parties currently possessing jointly purchased items subject to a consecutive ownership distribution are scheduled to possess the jointly purchased items, whether joint purchasers over jointly purchased items subject to a concurrent ownership distribution have exceeded a possession or usage proportion allocated thereto, etc.).

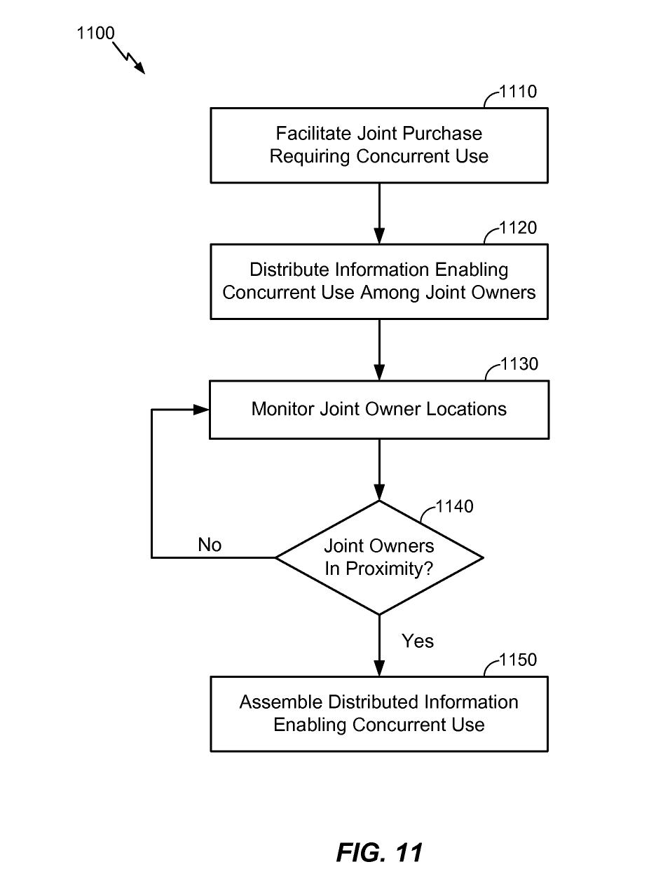

According to one aspect of the disclosure, FIG. 11 illustrates an exemplary method 1100 that may be used to manage a joint purchase among multiple parties according to an ownership distribution requiring concurrent use among the multiple parties. More particularly, at block 1110, multiple parties may agree to a joint purchase subject to an ownership distribution that requires concurrent use among the multiple parties. For example, in one embodiment, the joint purchase may comprise an electronic item such that the various joint owners can only use the jointly purchased electronic item concurrently, which may occur when all joint owners or a threshold number of the joint owners are located in proximity to one another. Accordingly, to ensure that the various joint owners are located in proximity and thereby manage the joint purchase according to the ownership distribution that requires concurrent use, information that enables the concurrent use may be distributed among the various joint owners at block 1120. For example, if the joint purchase comprises a digital movie, a digital song, or another suitable electronic item, portions thereof may be distributed among IoT devices associated with the various joint owners at block 1120 such that the complete electronic item can only be assembled and rendered when all joint owners or a threshold number of the joint owners are proximally located and their respective IoT devices are able to establish a proximal peer-to-peer connection. In another example, the electronic item may require a license key or other suitable authentication credential in order to enable use, whereby portions of the authentication credential may be similarly distributed among the various joint owners at block 1120 such that the complete authentication credential can only be assembled to enable use of the electronic item when all joint owners or a threshold number of the joint owners are proximally located. In this case, the full electronic item may be provided to each joint owner and the distributed authentication credential may provide the mechanism to ensure that the various joint owners can use the electronic item concurrently. However, portions of the jointly owned electronic item may be further distributed among the various joint owners 1120 to provide an additional constraint on the concurrent use, if appropriate. In still another example, where the joint purchase comprises an IoT device or other suitable device that can be controlled in an IoT network, the information distributed at block 1120 may comprise a token or other suitable data that can be assembled when IoT devices associated with the various joint owners are in proximity, whereby the jointly purchased item can only be used when the token is able to be assembled due to the various joint owners being in proximity to one another (e.g., a supervisor node in the IoT network may disable an on-off switch associated with the jointly purchased IoT device and only enable the on-off switch when all joint owners or a threshold number of the joint owners are in proximity to ensure that any use thereof is concurrent). In still another example, the joint purchase may be managed through a cloud service that may stream a jointly owned electronic item that may not necessarily be stored on any joint owner's device and only allow the jointly owned electronic item to be streamed in response to receiving information to confirm that all joint owners or a threshold number of the joint owners are located in suitable proximity to one another). Accordingly, those skilled in the art will appreciate that various different mechanisms may be used to ensure that the various joint owners are proximally located in order to restrict usage associated with a joint purchase unless all joint owners or a threshold number of joint owners are concurrently present.

In various embodiments, at block 1130, locations associated with the various joint owners may then be monitored and a determination may be made at block 1140 as to whether all joint owners or a threshold number of the joint owners are in proximity, depending on the particular constraints associated with the concurrent use distribution. For example, in one embodiment, the joint owners may be assumed to be in proximity at block 1140 in response to determining that a proximity-based distributed bus has been formed among IoT devices associated with the various joint purchasers (e.g., according to the mechanisms associated with the proximity-based peer-to-peer protocol described in further detail above with respect to FIGS. 5-7). In another embodiment, one or more proximity sensors may determine users that are present in order to determine whether the joint owners are in proximity. In any case, in response to determining that all joint owners or an appropriate number of the joint owners are in proximity, the information distributed among the joint owners that enables the concurrent use may be assembled at block 1150, thereby enabling the concurrent use. Otherwise, in response to determining at block 1140 that one or more joint owners are not present or that the number of the joint owners that are in proximity does not meet a suitable threshold value, use of the joint purchase may remain restricted and locations associated with the joint owners may continue to be monitored at blocks 1130 and 1140 until all joint owners are present or the number of the joint owners that are in proximity meets the suitable threshold value.

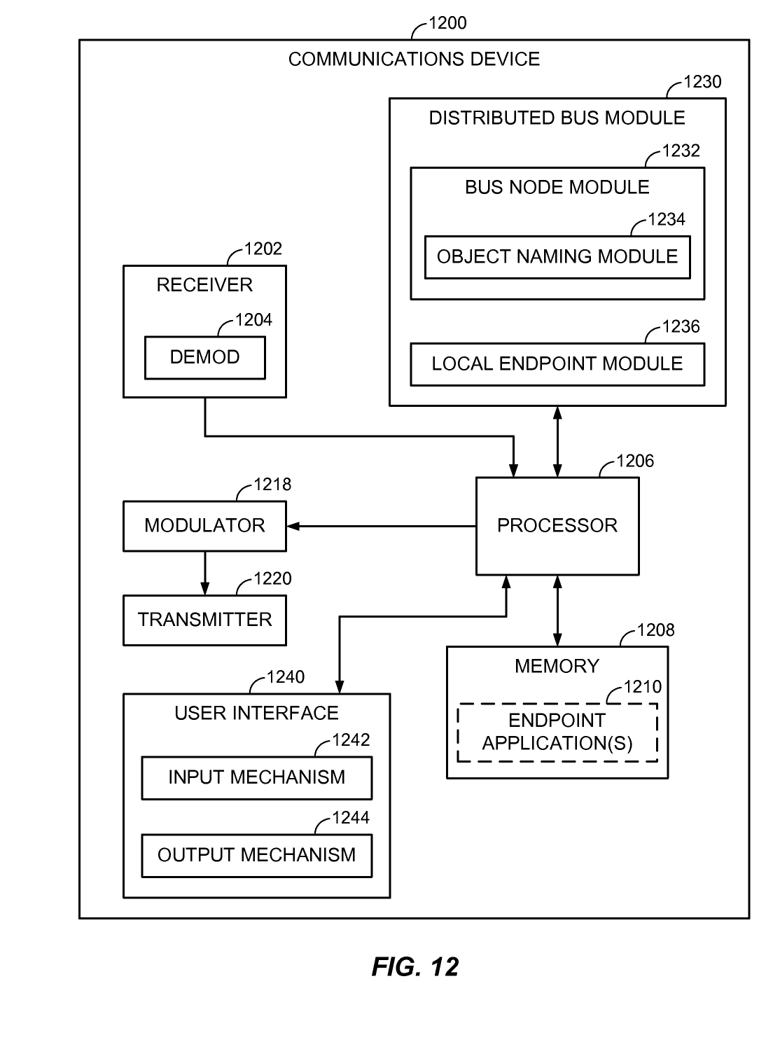

According to one aspect of the disclosure, FIG. 12 illustrates an exemplary communications device 1200 that may support discoverable P2P services to communicate over a proximity-based distributed bus with other communications devices to track and manage joint purchase ownership distributions. For example, in one embodiment, each joint purchaser may have one or more devices that have certain components and/or support certain functionalities associated with the communications device 1200 shown in FIG. 12, whereby the devices that different joint purchasers have may communicate with one another over a proximity-based distributed bus to track or otherwise manage an agreed-upon ownership distribution among the different joint purchasers.

In particular, as shown in FIG. 12, communications device 1200 may comprise a receiver 1202 that may receive a signal from, for instance, a receive antenna (not shown), perform typical actions on the received signal (e.g., filtering, amplifying, downconverting, etc.), and digitize the conditioned signal to obtain samples. The receiver 1202 can comprise a demodulator 1204 that can demodulate received symbols and provide them to a processor 1206 for channel estimation. The processor 1206 can be a processor dedicated to analyzing information received by the receiver 1202 and/or generating information for transmission by a transmitter 1220, a processor that controls one or more components of communications device 1200, and/or a processor that both analyzes information received by receiver 1202, generates information for transmission by transmitter 1220, and controls one or more components of communications device 1200.

Communications device 1200 can additionally comprise a memory 1208 that is operatively coupled to processor 1206 and that can store data to be transmitted, received data, information related to available channels, data associated with analyzed signal and/or interference strength, information related to an assigned channel, power, rate, or the like, and any other suitable information for estimating a channel and communicating via the channel. In one aspect, the memory 1208 can include local endpoint applications 1210, which may seek to communicate with endpoint applications, services etc., on communications device 1200 and/or other communications devices 1200 associated through distributed bus module 1230. Memory 1208 can additionally store protocols and/or algorithms associated with estimating and/or utilizing a channel (e.g., performance based, capacity based, etc.).

It will be appreciated that data store (e.g., memory 1208) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 1208 of the subject systems and methods may comprise, without being limited to, these and any other suitable types of memory.

Communications device 1200 can further include distributed bus module 1230 to facilitate establishing connections with other devices, such as communications device 1200. Distributed bus module 1230 may further comprise bus node module 1232 to assist distributed bus module 1230 managing communications between multiple devices. In one aspect, a bus node module 1232 may further include object naming module 1234 to assist bus node module 1232 in communicating with endpoint applications 1210 associated with other devices. Still further, distributed bus module 1230 may include endpoint module 1236 to assist local endpoints in communicating with other local endpoints and/or endpoints accessible on other devices through an established distributed bus. In another aspect, distributed bus module 1230 may facilitate inter-device and/or intra-device communications over multiple available transports (e.g., Bluetooth, UNIX domain-sockets, TCP/IP, Wi-Fi, etc.). Accordingly, in one embodiment, the distributed bus module 1230 and the endpoint applications 1210 may be used to establish a proximity-based distributed bus with communication devices 1200 that other joint purchasers own such that a jointly owned electronic item subject to a concurrent ownership distribution can only be rendered when the communication devices 1200 associated with the various joint purchasers are located within sufficient proximity to establish the proximity-based distributed bus.

Additionally, in one embodiment, communications device 1200 may include a user interface 1240, which may include one or more input mechanisms 1242 for generating inputs into communications device 1200, and one or more output mechanisms 1244 for generating information for consumption by the user of the communications device 1200. For example, input mechanism 1242 may include a mechanism such as a key or keyboard, a mouse, a touch-screen display, a microphone, etc. Further, for example, output mechanism 1244 may include a display, an audio speaker, a haptic feedback mechanism, a Personal Area Network (PAN) transceiver etc. In the illustrated aspects, the output mechanism 1244 may include an audio speaker operable to render media content in an audio form, a display operable to render media content in an image or video format and/or timed metadata in a textual or visual form, or other suitable output mechanisms. However, in one embodiment, a headless communications device 1200 may not include certain input mechanisms 1242 and/or output mechanisms 1244 because headless devices generally refer to computer systems or device that have been configured to operate without a monitor, keyboard, and/or mouse.

Furthermore, in one embodiment, the user interface 1240 may be used to view information associated with a joint purchase facilitated, tracked, or otherwise managed through a joint purchasing service. For example, in one embodiment, a joint purchaser may install a suitable application on the communications device 1200 or otherwise communicate with the joint purchasing service to view the information associated with the joint purchase through the user interface 1240 (e.g., the communications device 1200 may communicate with the joint purchasing service over a suitable network connection to request the joint purchase information and display information received from the joint purchasing service on the user interface 1240). Accordingly, the user interface 1240 may display ownership distribution information that the joint purchasing service tracks and maintains and/or other information relevant to the joint purchase (e.g., jointly purchased items associated with a particular user, information relating to locations, usage statistics, or other state data relating to jointly purchased items associated with the user, parties currently possessing jointly purchased items associated with the user, how long parties currently possessing jointly purchased items subject to a consecutive ownership distribution are scheduled to possess the jointly purchased items, whether joint purchasers over jointly purchased items subject to a concurrent ownership distribution have exceeded a possession or usage proportion allocated thereto, etc.).

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for managing joint purchases, comprising:
providing a joint purchasing service to facilitate a joint purchase among multiple parties that have agreed to enter into the joint purchase; and
tracking the joint purchase according to an ownership distribution that the multiple parties to the joint purchase have agreed upon, wherein the ownership distribution defines one or more rules that control access to the joint purchase according to one or more of locations or proximity associated with the multiple parties.

2. The method recited in claim 1, wherein the multiple parties comprise a primary purchaser and one or more peer purchasers that the primary purchaser identified in a peer network associated with the primary purchaser.

3. The method recited in claim 1, further comprising:
receiving a request to facilitate the joint purchase from a primary purchaser;
offering the joint purchase to a subscriber base associated with the joint purchasing service subject to one or more restrictions; and
including one or more peer purchasers solicited from the subscriber base in the joint purchase in response to the one or more peer purchasers accepting the offered joint purchase and the one or more restrictions associated therewith.

4. The method recited in claim 1, wherein the joint purchasing service is provided through one or more a vendor offering to sell one or more items associated with the joint purchase or a third-party intermediary that facilitates the joint purchase between the vendor and the multiple parties that have agreed to enter into the joint purchase.

5. The method recited in claim 1, further comprising:
receiving billing details associated with the multiple parties from a primary purchaser, wherein the multiple parties that have agreed to enter into the joint purchase comprise the primary purchaser and one or more additional joint purchasers; and
implementing one or more security controls to confirm that the one or more additional joint purchasers have agreed to enter into the joint purchase.

6. The method recited in claim 1, further comprising:
receiving, from a primary purchaser among the multiple parties, billing details associated with the primary purchaser and contact information associated with one or more additional joint purchasers; and
communicating with the one or more additional joint purchasers using the received contact information to request billing details associated with the one or more additional purchasers and a split cost that each additional purchaser agrees to pay.

7. The method recited in claim 1, wherein the ownership distribution that the multiple parties agreed upon comprises a consecutive ownership distribution schedule in which a current party has a right to possess and use one or more items associated with the joint purchase until a first predefined time period expires and the right to possess and use the one or more items is transferred to a next party until a second predefined time period expires after the first predefined time period expires.

8. The method recited in claim 7, wherein tracking the joint purchase comprises:
tracking location information associated with the one or more items; and
notifying the current party and the next party to indicate that the right to possess and use the one or more items has been transferred to the next party in response to the tracked location information indicating that the current party has possessed the one or more items for the first predefined time period.

9. The method recited in claim 7, wherein tracking the joint purchase comprises:
determining that the joint purchase comprises an electronic item; and
automatically transferring the jointly purchased electronic item from the current party to the next party after the first predefined time period expires.

10. The method recited in claim 1, wherein the ownership distribution that the multiple parties agreed upon comprises a concurrent ownership distribution schedule in which the multiple parties each have the right to possess and use an item associated with the joint purchase subject to percentages or proportions allocated among the multiple parties.

11. The method recited in claim 10, wherein tracking the joint purchase comprises:
tracking state information associated with the jointly purchased item to determine actual possession and usage distributions among the multiple parties, wherein the tracked state information includes at least one of location information or usage statistics; and
notifying the multiple parties in response to determining that the actual possession and usage distributions among the multiple parties has deviated from the percentages or proportions allocated among the multiple parties.

12. The method recited in claim 1, wherein the ownership distribution that the multiple parties agreed upon comprises a concurrent ownership distribution schedule that requires proximity among at least two of the multiple parties to enable use of one or more items associated with the joint purchase.

13. The method recited in claim 12, wherein tracking the joint purchase comprises:
distributing information enabling concurrent use of the one or more items among the multiple parties such that the distributed information can only be assembled to enable the concurrent use when the at least two of the multiple parties are in proximity.

14. The method recited in claim 13, wherein the distributed information comprises one or more of portions of the one or more items or portions of a token.

15. The method recited in claim 13, wherein tracking the joint purchase comprises:
determining that the at least two of the multiple parties are in proximity in response to devices associated with the at least two parties establishing a distributed bus according to a proximity-based peer-to-peer protocol; and
assembling the distributed information enabling the concurrent use of the one or more items at a node located on the proximity-based distributed bus.

16. The method recited in claim 1, further comprising:
providing a user interface that enables the multiple parties to view one or more items associated with the joint purchase and tracked state information associated with the one or more items.

17. A server for managing joint purchases, comprising:
means for facilitating a joint purchase among multiple parties that have agreed to enter into a joint purchase; and
means for tracking the joint purchase according to an ownership distribution that the multiple parties to the joint purchase have agreed upon, wherein the ownership distribution defines one or more rules that control access to the joint purchase according to one or more of locations or proximity associated with the multiple parties.

18. The server recited in claim 17, wherein the ownership distribution that the multiple parties agreed upon comprises a consecutive ownership distribution schedule in which a current party has a right to possess and use one or more items associated with the joint purchase until a first predefined time period expires and the right to possess and use the one or more items is transferred to a next party until a second predefined time period expires after the first predefined time period expires.

19. The server recited in claim 18, wherein the means for tracking the joint purchase comprises:
means for tracking location information associated with the one or more items; and
means for notifying the current party and the next party to indicate that the right to possess and use the one or more items has been transferred to the next party in response to the tracked location information indicating that the current party has possessed the one or more items for the first predefined time period.

20. The server recited in claim 18, wherein the means for tracking the joint purchase comprises:
means for determining that the joint purchase comprises an electronic item; and
means for automatically transferring the jointly purchased electronic item from the current party to the next party after the first predefined time period expires.

21. The server recited in claim 17, wherein the ownership distribution that the multiple parties agreed upon comprises a concurrent ownership distribution schedule in which the multiple parties each have the right to possess and use an item associated with the joint purchase subject to percentages or proportions allocated among the multiple parties.

22. The server recited in claim 21, wherein the means for tracking the joint purchase comprises:
means for tracking state information associated with the jointly purchased item to determine actual possession and usage distributions among the multiple parties, wherein the tracked state information includes at least one of location information or usage statistics; and
means for notifying the multiple parties in response to determining that the actual possession and usage distributions among the multiple parties has deviated from the percentages or proportions allocated among the multiple parties.

23. The server recited in claim 17, wherein the ownership distribution that the multiple parties agreed upon comprises a concurrent ownership distribution schedule that requires proximity among at least two of the multiple parties to enable use of one or more items associated with the joint purchase.

24. The server recited in claim 23, further comprising:
means for distributing information enabling concurrent use of the one or more items among the multiple parties such that the distributed information can only be assembled to enable the concurrent use when the at least two of the multiple parties are in proximity.

25. A computer-readable storage medium having computer-executable instructions recorded thereon, wherein executing the computer-executable instructions on a server causes the server to:
facilitate a joint purchase among multiple parties that have agreed to enter into a joint purchase; and
track the joint purchase according to an ownership distribution that the multiple parties to the joint purchase have agreed upon, wherein the ownership distribution defines one or more rules that control access to the joint purchase according to one or more of locations or proximity associated with the multiple parties.

26. A method for making and tracking joint purchases, comprising:
communicating with a joint purchasing service using a device associated with a first user to initiate a joint purchase with one or more second users that have agreed to enter into the joint purchase with the first user;
communicating with the joint purchasing service to specify an ownership distribution associated with the joint purchase, wherein the ownership distribution defines one or more rules that the first user and the one or more second users have agreed upon to control access to the joint purchase;
receiving, at the device associated with the first user, state information tracking one or more items associated with the joint purchase according to the specified ownership distribution, wherein the received state information tracks the one or more items according to one or more of location or proximity information; and
displaying, at the device associated with the first user, information corresponding to the one or more items associated with the joint purchase and the received state information tracking the one or more items associated with the joint purchase.

27. The method recited in claim 26, further comprising:
receiving, at the device associated with the first user, a notification indicating that a right to possess and use the one or more items has been transferred from a current user to a next user after the current user has possessed the one or more items for a first predefined time period, wherein the specified ownership distribution comprises a consecutive ownership distribution schedule in which the current user has the right to possess and use the one or more items until the first predefined time period expires and the right to possess and use the one or more items is then transferred to the next user until a second predefined time period expires.

28. The method recited in claim 26, further comprising:
receiving, at the device associated with the first user, a notification indicating that actual possession and usage distributions among the first user and the one or more second users has deviated from percentages or proportions that the specified ownership distribution allocates among the first user and the one or more second users.

29. The method recited in claim 26, further comprising:
receiving, at the device associated with the first user, a portion of information enabling concurrent use of the one or more items, wherein the information enabling the concurrent use of the one or more items is distributed among the device associated with the first user and devices associated with the one or more second users;
establishing a distributed bus among the device associated with the first user and at least one of the devices associated with the one or more second users according to a proximity-based peer-to-peer protocol; and
assembling the information distributed among the device associated with the first user and the at least one of the devices associated with the one or more second users at a node located on the proximity-based distributed bus to enable the concurrent use of the one or more items.

30. The method recited in claim 26, wherein the one or more items associated with the joint purchase include at least one electronic item, and wherein the method further comprises:
automatically transferring the jointly purchased electronic item to or from the device associated with the first user according to the one or more rules defined in the specified ownership distribution.
